(19) United States
(12) Patent Application Publication
(10) Pub. No.: US 2006/0029912 A1
(43) Pub. Date: Feb. 9, 2006

(54) Aural rehabilitation system and a method of using the same

(75) Inventors: Gerald W. Kearby, Loma Mar, CA (US); Earl I. Levine, Palo Alto, CA (US); A. Robert Modeste, Redwood City, CA (US); Douglas J. Dayson, Belmont, CA (US); Jamie Macbeth, Los Angeles, CA (US)

Correspondence Address: LEVINE BAGADE LLP, 2483 EAST BAYSHORE ROAD, SUITE 100, PALO ALTO, CA, 94303, US

(73) Assignee: Neuro Tone, Inc., Redwood City, CA (US)

(21) Appl. No.: 11/151,820

(22) Filed: Jun. 13, 2005

Related U.S. Application Data
(60) Provisional application No. 60/578,944, filed on Jun. 12, 2004.
(60) Provisional application No. 60/579,039, filed on Jun. 12, 2004.
(60) Provisional application No. 60/619,374, filed on Oct. 14, 2004.
(60) Provisional application No. 60/666,864, filed on Mar. 31, 2005.

(51) Int. Cl. G06K 9/00

(52) U.S. Cl. 434/116

(57) ABSTRACT

A system 2 and method 64 for neurological rehabilitation or training is disclosed. The system 2 can be used to improve listening, comprehension, and communication. The system 2 can be controlled automatically by a remote device 6 or manually by a physician's device 4. The system 2 can store data in, and retrieve data from a database 10 for analysis, reporting and execution. The system 2 can adapt and adjust based on the subject's performance. The system 2 can be used to treat hearing loss, tinnitus or other audiological health problems.

### CROSS-REFERENCE TO RELATED APPLICATIONS

This application claims the benefit of U.S. provisional application Nos. 60/578,944 and 60/579,039, both filed 12 Jun. 2004, U.S. provisional application No. 60/619,374, filed 14 Oct. 2004, and U.S. provisional application No. 60/666,864, filed 19 Apr. 2005, all of which are incorporated by reference in their entireties herein.

### BACKGROUND OF THE INVENTION

1. Field of the Invention

The present invention relates generally to a system for neurological (e.g., aural) rehabilitation and/or treatment and/or therapy, such as for listening and comprehension, and a method of using the same.

2. Description of the Related Art

Increased age and hearing deficiencies can impair cognitive function, contextual skills, temporal processing and interactive communication skills. For example, individuals with sensorineural hearing loss (comprising over 90% of hearing aid users) have greater difficulty processing speech in noise than their normal hearing counterparts. Part of the reason for this difficulty relates to the reduction in tuning (i.e., broadened filters) in the peripheral auditory mechanism (i.e., the cochlea). However, another major cause for difficulty relates to the central auditory mechanism (i.e., brain). It has been shown experimentally that auditory deprivation as well as the introduction of novel stimuli lead to altered cortical representation (i.e., auditory plasticity). It is not clear whether this altered neuronal function will result in improved or diminished ability to understand speech in adverse conditions once audibility is fully or partially restored with wearable amplification.

Furthermore, the average hearing-impaired adult delays getting professional services for approximately seven years after first recognizing that a hearing impairment is present. This period of time is more than sufficient to develop compensatory listening habits that, again, may be beneficial or may be detrimental. Regardless, once a person begins wearing hearing aids, the brain must again adapt to a new set of acoustic cues. Currently, there is little treatment beyond the fitting of the hearing aid to the hearing loss. One would not expect an amputee to be furnished with a new prosthetic device without some type of physical therapy intervention, yet this is precisely what is done for people receiving new hearing devices.

An exemplary speed of processing test, the Stroop test, consists of three parts: reading of color words, color naming, and an interference task. Stroop test subjects note the strong interference of word reading with color naming, called the Stroop interference effect (e.g. the word “red” printed in green requires the verbal response “green”). Additionally, a nomination score is quantified in terms of the difference in reaction times of reading of color words and color naming. The tendency to interference (selection) is quantified in terms of the difference in reaction times of color naming and the interference task. An activation of the frontal lobes occurs during the Stroop test in healthy subjects. The Stroop test has been used for diagnostic purposes, but not for aural rehabilitation purposes.

There exists a need for a neurological, for example aural, rehabilitation system and a method of using the same.

### BRIEF SUMMARY OF THE INVENTION

A neurological rehabilitation or training system is disclosed. Any time rehabilitation is mentioned herein, it may be replaced by training, as the subject can have a hearing or neurological loss or not. The neurological system can have audio architecture for use in audiological rehabilitation or training. The audio architecture can be configured to perform one or more audio engine tasks. The audio engine tasks can be dynamic mixing of sound and noise, delaying a signal such as during mixing two signals or a signal and noise, time compressing a signal, distorting a signal, equalizing a signal.

A method of using a neurological rehabilitation or training system is disclosed. The method includes altering one or more signals for the use in audiological treatment and/or training.

### BRIEF DESCRIPTION OF THE DRAWINGS

FIG. 1A illustrates mean results from objective QuickSIN™ testing at 45 dB on control (square) and training (circle) groups before and after use of the methods disclosed herein.

FIGS. 1B illustrates mean results from objective QuickSIN™ testing at 70 dB on control (square) and training (circle) groups before and after use of the methods disclosed herein.

FIG. 1C illustrates mean results from objective HINTS testing on control (square) and training (circle) groups before and after use of the methods disclosed herein.

FIGS. 2A through 2C illustrate test results from subjective measures on control and trained groups before and after use of the methods disclosed herein.

FIGS. 3A through 3E illustrate responses of the training group from a survey at the end of training.

FIG. 4A through 4E illustrate average improvement scores for the training group on the modules.

FIG. 5 illustrates an embodiment of an audiological treatment system.

FIG. 6 illustrates an embodiment of a local device.

FIG. 7 is a perspective view of an embodiment of a single earpiece.

FIG. 8 illustrates section A-A of the earpiece of FIG. 7.

FIG. 9 illustrates an embodiment of a method of audiological treatment.

FIG. 10 illustrates an embodiment of a method of initial audiological diagnosis.

FIG. 11 illustrates an embodiment of a method of determining if the patient is a suitable candidate for treatment.

FIG. 12 illustrates an embodiment of a method of sending the assessment data profile to the remote device.

FIG. 13 illustrates an embodiment of a method of sending data to produce and deliver the assessment report.

FIG. 14 illustrates an embodiment of a method of initial preparation of the local and remote devices.

FIG. 15 illustrates an embodiment of a method of the remote device producing an execution therapy report.

FIG. 16 illustrates an embodiment of a method of generating an initial recommended therapy report.

FIG. 17 illustrates an embodiment of a method of sending data to the database and the physician's device during initial patient assessment.

FIG. 18 illustrates an embodiment of a method of performing the prescribed evaluation and therapeutic use of the device.

FIG. 19 illustrates an embodiment of a method of the patient operating the local device.

FIG. 20 illustrates an embodiment of a method of synchronizing the local device and the remote device.

FIGS. 21 and 22 illustrate an embodiment of a method of data transfer during synchronization of the local device and the remote device.

FIG. 23 illustrates a method of sending data to the physician's device during or after the synchronization of the local device and the remote device.

FIG. 24 illustrates a method of sending data to the remote device and the database to update the therapy.

FIG. 25 illustrates an embodiment of a method of the remote device analyzing the treatment data.

FIG. 26 illustrates an embodiment of the aural rehabilitation system architecture.

FIG. 27 illustrates an embodiment of the aural rehabilitation system that can include (the use of) a WAN 164 or the internet.

FIG. 28 illustrates a schematic diagram of an embodiment of a local device.

FIGS. 29 and 30 illustrate various embodiments of the hardware interface.

FIG. 31 illustrates an embodiment of an adaptive threshold training system architecture and subject.

FIG. 32 illustrates an embodiment of an adaptive threshold training system architecture.

FIG. 33 illustrates a method for adaptive threshold training.

### DETAILED DESCRIPTION

A system 2 for neurological rehabilitation, such as aural rehabilitation, treatment or training, can have an electronics hardware platform and/or software programs. The system 2 can perform one or more neurological exercise modules, such as aural rehabilitation or training exercise modules. (Rehabilitation, training and treatment are non-limitingly used interchangeably within this description.)

Examples of the modules are described in the poster The Word In Context Intelligibility Test (WICIT), by Cox et al. and Presented at the American Academy of Audiology National Convention, Dallas, Tex. 1995, and “The Case for LACE: Listening and Auditory Communication Enhancement Training”, both of which are incorporated herein in their entireties.

Each module can be used to diagnose and/or provide treatment and/or therapy to a subject. The modules can be used as neurological training exercises. The modules can be cognitive modules, degraded speech modules, competing speech modules, context (i.e., contextual) modules, interactive communication modules, or combinations thereof. The cognitive modules can train, for example, auditory working memory and/or speed of processing. The context modules can address linguistics.

Cognitive Module

The cognitive modules, for example training auditory memory modules or working memory modules, can audibly play a series of words. The series of words can be a sentence. The subject can be asked to remember or recall an answer word in the series before a target word in the series. The subject can be asked to speak the answer word after the audible playing of the series.

The working memory module can be made more difficult, for example, by asking for multiple answer words for each series (e.g., “What comes before ‘seven’, ‘given’ and ‘fortune.’), by playing multiple series (e.g., multiple sentences), by increasing the length and/or number of words in the series (e.g., longer sentences), by dividing the subject's attention, for example, with an additional memory task such as by asking the subject to answer questions regarding the substantive content of the series of words (e.g., “What did the dog do with the bone?”), or combinations thereof. The working memory module can be made less difficult, for example, by asking for less answer words for each series, by playing fewer series, by decreasing the length and/or number of words in the series (e.g., shorter sentences), or combinations thereof.

For example, the working memory module can ask the subject to say out loud the answer word that comes just before the target word. The target word in the following example can be “out.” The module can then audibly play the series of words, “The concert was sold out last week.” The answer word is “sold.”

The subject can repeat use of the cognitive modules. The target words and series of words can vary from one use to the next use.

The difficulty of the cognitive module can vary adaptively based on performance. A working memory and/or cognitive skill score can be recorded for the subject. If the subject responds with the correct answer word, the appropriate (e.g., working memory and/or cognitive) skill scores can be increased. If the subject responds with the incorrect answer word, the appropriate skill score can be decreased. As the working memory and/or cognitive skill score increases, the cognitive module can be made more difficult. As the working memory and/or cognitive skill score increases, the cognitive module can be made less difficult.

Other working memory modules can include, for example, use of digit, word, sentence, span, visio-spatial tests, or combinations thereof. The module can audibly play a sequence of numbers, letters, words, sentences or other data, for example the sequence “6, 2, 8.” The subject can be asked to reverse the order of the sequence, for example, the correct response to the sequence supra is “8, 2, 6.” Performing repeated tests for the Wechsler Adult Intelligence Scale (WAIS) can be used as a working memory module.

Performing repeated Pitch Pattern Sequence (PPS) tests can be used as a working memory module. PPS tests audibly play high frequency and low frequency tones of brief durations arranged in groups of three. The subject is evaluated based on the subject's correct recollection of the pattern of high and low frequencies. PPS tests are known to those having ordinary skill in the art.

The working memory module can, for example, present the subject with a number (e.g., five) of sentences. The subject can then be asked to determine if the sentences were meaningful, and to recall the last and/or first words in the sentences.

The cognitive modules can train the speed of neurological processing, for example, speech processing. The cognitive module can train the subject on auditory related tasks (e.g., the target and answer word cognitive module described supra) with the use of a timer. The subject can attempt to improve their best response time for each set of training data. The subject's response time can be incorporated into the subject's appropriate skill score, and/or a speed of processing skill score.

Existing neurological speed tests that can be modified for use in the cognitive module, such as for a global processing speed module, include, for example, the Stroop Test, Trail Making Tests, and letter or pattern comparison tasks. The Trail Making Tests can also be used to assess executive function.

Degraded Speech Module

The degraded speech module, for example a time-compression speech module, can audibly play low, and/or medium, and/or high predictability series of words (e.g., sentences), or a single word (inclusively referred to as a series for simplicity). The series of words can be on-going, contextually related words. An example series of words is, “Thirty miles was too far.” The series of words can be degraded, for example time-compressed, compared to normal speech.

The time compression can be, for example, about 60%. The time-compression can be performed using pitch-synchronous overlap and add (PSOLA). PSOLA is a method for manipulating the pitch and duration of an acoustic speech signal known to those having ordinary skill in the art.

The subject can then be asked to identify the series of words. If the subject correctly identifies the series of words, a degraded speech skill score and/or a speed of processing skill score can be increased. If the subject fails to correctly identify the series of words, the degraded speech skill score and/or the speed of processing skill score can be decreased.

The subject can repeat use of the degraded speech module. The degrading (e.g., time-compression) can vary adaptively based on performance. When the degraded speech skill score and/or the speed of processing skill score decreases, the degrading can be decreased. When the degraded speech skill score and/or the speed of processing skill score increases, the degrading can be increases.

Competing Speech Module

The competing speech module, for example, a speech in noise (i.e., speech in babble) module, can audibly play low, and/or medium, and/or high predictability series of words (e.g., sentences), or a single word (inclusively referred to as a series for simplicity) and simultaneous play noise. The speech in noise can have multiple channels. Any and/or all channels can broadcast from different speakers. The series of words can be on-going, contextually related words. An example series of words is, “The glasses were on the kitchen table.” The noise can be one or more simultaneous speech samples. The amplitude of the signal (i.e., speech) to the amplitude of the noise (i.e., signal to noise ratio) can be controlled during use of the competing speech module.

The subject can be asked to identify the series of words. If the subject correctly identifies the series of words, a competing speech skill score and/or a speech in noise skill score can be increased. If the subject fails to correctly identify the series of words, the competing speech skill score and/or the speech in noise skill score can be decreased.

The subject can repeat use of the competing speech module. The signal to noise ratios can vary adaptively based on performance. If the competing speech skill score and/or the speech in noise skill score increases, the signal to noise ratio can be lowered and/or the predictability of the series of words can be decreased. If the competing speech skill score and/or the speech in noise skill score decreases, the signal to noise ratio can be increased and/or the predictability of the series of words can be increased.

A Speech Perception in Noise (SPIN) test can be repeatedly performed to provide rehabilitation. SPIN tests can adjust the predictability of the series of words depending on the value and/or change in the competing speech and/or the speech in noise skill score.

Existing speech in noise tests that can be modified for use in the speech in noise module include, for example, QuickSIN™ (from Etymotic Research, Inc., Elk Grove Village, Ill.) and the Hearing In Noise Test (HINT®)(from Maico Diagnostics, Eden Prairie, Minn.).

Context Module

The context module, for example, a missing word module, can audibly play low, and/or medium, and/or high predictability series of words (e.g., sentences). The series of words can be on-going, contextually related words. The subject can be asked to provide linguistic closure to a series of words with a contextually appropriate word missing from the sentence.

An example series of words is, “The dog chewed on a *.” The “*” can represent a missing word. The “*” can be audibly played as a tone, masked version of the missing word, a nonsense word, another noise, or silence. The subject can be provided with multiple choices (e.g., bone, cat, tree, and wall) from which to select the missing word (e.g., bone). The context module can include a categorical hint (e.g., sports, world events, weather, celebrities, geography).

If the subject correctly identifies the missing word, a context skill score and/or a missing word skill score can be increased. If the subject fails to correctly identify the missing word, the context skill score and/or the missing word skill score can be decreased.

The subject can repeat use of the context speech module. The difficulty of the context module can vary adaptively based on performance. If the context skill score and/or the missing word skill increases, the difficulty of the context module can be increased. If the context skill score and/or the missing word skill decreases, the difficulty of the context module can be decreased.

The difficulty of the context module can be increased, for example, by increasing the length of the individual words, or the number of words in the series of words, or making the sentences more grammatically or substantively complex, or combinations thereof. The difficulty of the context module can be decreased, for example, by decreasing the length of the individual words, or the number of words in the series of words, or making the sentences less grammatically or substantively complex, or combinations thereof.

Existing context tests that can be modified for use in the context module include, for example, The Word in Context Intelligibility Test (WICIT).

Interactive Communication Module

The interactive communication module can instruct the subject on methods to improve the subject's environmental and/or personal behavior strategies to maximize the subject's neurological, for example listening, comprehension and communication effectiveness.

The interactive communication module can instruct the subject regarding beneficial listening and repair strategies, how to control the subject's environment, how to be assertive so as to improve the subject's environment (e.g., instructing the subject not to be too shy to ask someone else to repeat their speech when the speech is not understood), setting realistic expectations for their neurological (e.g., listening, comprehension or communication) performance level, how to manage the subject's stress level, how to perform speech reading at least at a basic level, understanding the Americans with Disabilities Act (ADA) and rights thereby available, skills (e.g., helpful hints) for the subject when communicating with the subject's spouse, skills (e.g., helpful hints) for the subject's spouse when communicating with the subject, restaurant skills (e.g., to ask for another table in a restaurant when the subject is sat near a noisy kitchen), hearing aid use and care, or combinations thereof.

The interactive communication module can provide rehabilitation or therapy to improve conversation skills. For example, the interactive communication module can include an adaptive assessment of sentence perception (Sent-Ident) exercise. A series of words (e.g., a set of simple sentences), for example, “Her father put the milk on the table”, can be spoken. The speaker's mouth can be visually covered from the subject's perspective. If the subject does not hear the series of words correctly, the speaker can present the series of words again, under progressively easier conditions (e.g., repetition, clarification, the speaker's mouth visible while saying one word, the speaker's mouth visible while saying all words) until the series of words is identified correctly.

The subject can be tested regarding the subject's knowledge of the information taught by the interactive communication module, for example with a basic neurological (e.g., aural) rehabilitation knowledge questionnaire. The subject's ability to respond correctly regarding the information taught by the interactive communication module can be recorded as an interactive communication skill score.

The interactive communication module can include single or repeated use of subjective tests to produce a diagnostic, therapeutic or rehabilitative effect. The subjective tests can include, for example, Abbreviated Profile of Hearing Aid Benefit (APHAB), Communication Profile for the Hearing Impaired (CPHI), Client Oriented Scale of Improvement (COSI), and other assessment methods known to those having ordinary skill in the art, or combinations thereof. APHAB is a 24-item self-assessment inventory in which patients report the amount of trouble they are having with communication or noises in various everyday situations. APHAB is known to those having ordinary skill in the art. CPHI is a self-assessment inventory that communication effectiveness, communication importance, communication environment, communication strategies, and personal adjustment in hearing-impaired adults. COSI is known to those having ordinary skill in the art. The results from the assessment tools and the skill scores supra can be combined into appropriately titled skill scores. The subject can perform self-evaluation of rehabilitation performance.

A total and/or sub-total skill scores can be computed as functions of the skill scores for the modules. When a module is initially performed with a given subject, that subject's skill scores can be recorded as baseline scores for future reference. The skill scores can be tracked over time to determine a subject's change in listening and comprehension. If the skill scores decrease over time, the difficulty of the modules can be decreased. If the skill scores increase over time, the difficulty of the modules can be increased.

The inventive method can enhance and improve listening, comprehension and communication skills and improve confidence levels. The inventive method can improve cognitive function, and/or contextual skills, and/or linguistic skills, and/or temporal processing, and/or interactive communication skills.

The audibly played text and other substantive data used in the modules, can be selected to be topically relevant to the subject's personal selection, and can be updated to maintain timely relevance (e.g., news feeds). For example, the modules can contain text and substantive data that can be particularly relevant to dogs for “dog-loving” subjects, and particularly relevant to politics for “politics-loving” subjects.

The modules can be provided for the subject to take to the subject's home and/or perform at the subject's home. The modules can be recorded onto digital media (CD-ROM) and, for example, used on the subject's home computer. The modules can be performed on a personal digital assistant (PDA), and/or other portable handheld devices. The subject's progress can be monitored remotely, for example by a health professional.

“The case for LACE, individualized listening and auditory communication enhancement training”: Sweetow, R. W. and Henderson-Sabes, J. H.: The Hearing Journal, Vol. 57, No. 3, 32-40, 2004 is herein incorporated by reference in its entirety. The rehabilitation methods disclosed herein can be performed on subjects with or without hearing aids.

Subject Data

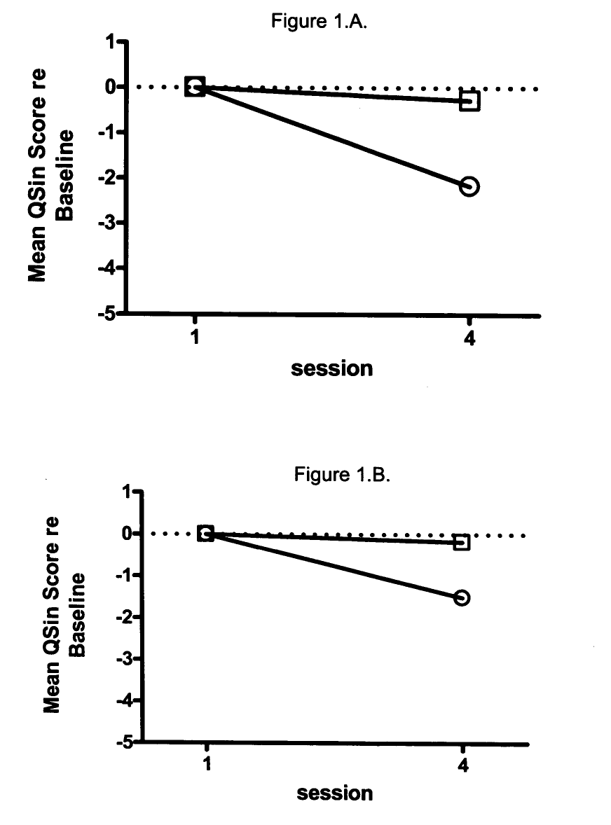

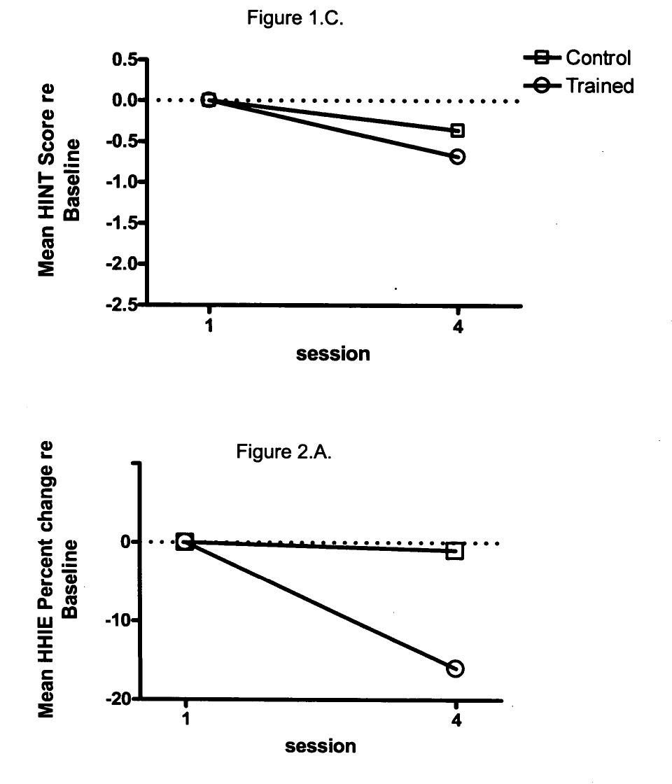

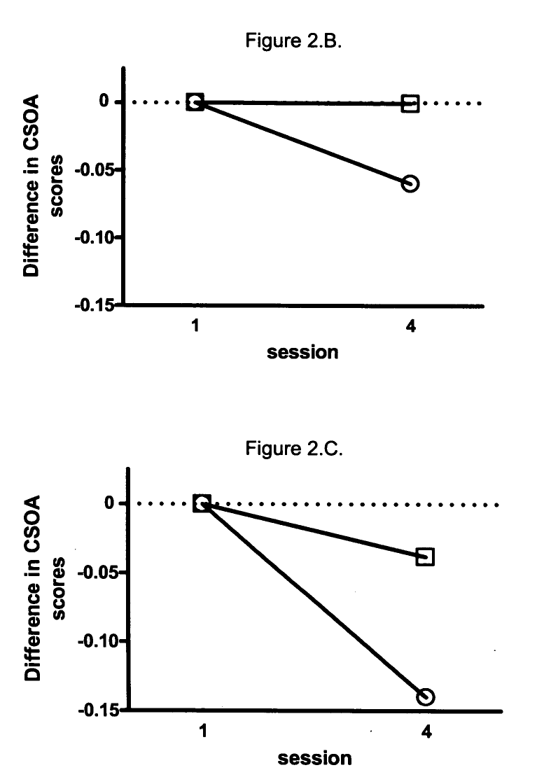

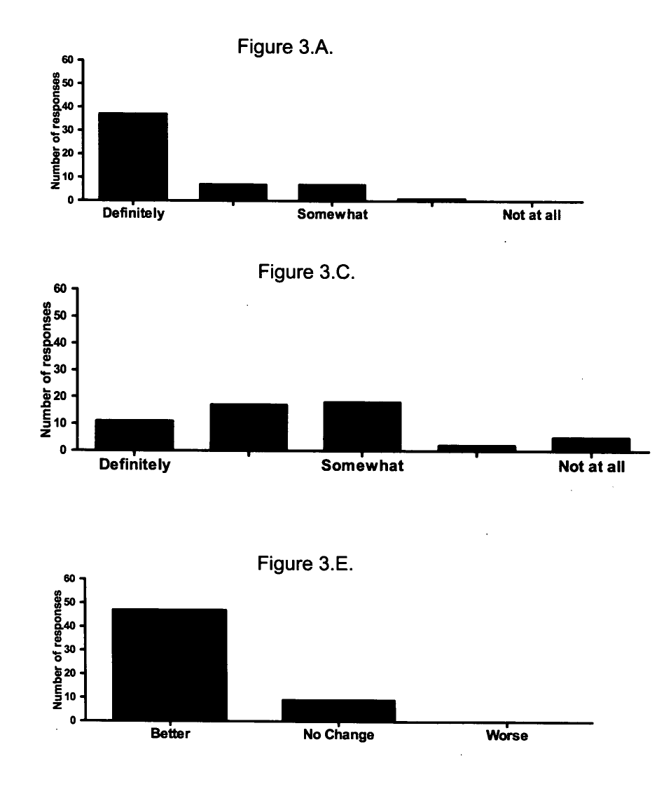

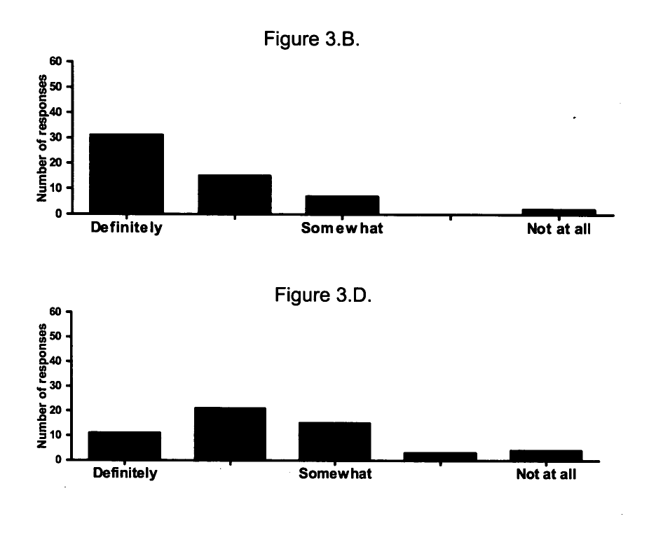

A randomized cross-over design multi-site study was conducted to determine the efficacy of the methods disclosed herein. Fifty subjects (“trained group”) performed training with the methods disclosed herein for four weeks. The training included training each day with one, two to three modules for 30 minutes for each module for five days per week. Thirty control subjects (“control group”) did not perform the methods disclosed herein. Performance data were collected from the trained group and the control group. The performance data demonstrated statistically significant improvements in hearing performance for the trained group compared to the control group on objective measures (e.g., improvements in speech recognition for degraded conditions such as background noise, shown in FIGS. 1A through 1C,) and subjective measures (e.g., the standardized Hearing Handicap for Elderly (HHIE), Hearing Handicap for Adults, and Communication Strategies for Older Adults (CS OA), shown in FIGS. 2A through 2C, and survey responses shown in FIGS. 3A through 3E).

The performance data shown in FIGS. 1A through 1C and 2A through 2C were collected from the subjects at a baseline session (session 1) and a session 4 weeks later (session 4). A decrease in score indicates an improvement in the subject's real or perceived hearing. The dotted line indicates no change in score.

FIG. 1A illustrates average subject performance data for the trained (shown as squares) and the control (shown as circles) groups for the QuickSIN™ competing speech module at 45 dB. FIG. 1B illustrates average subject performance data for the trained (shown as squares) and the control (shown as circles) groups for the QuickSIN™ competing speech module at 70 dB. FIG. 1C illustrates average subject performance data for the trained (shown as squares) and the control (shown as circles) groups for the HINT competing speech module.

FIG. 2A illustrates the average subject performance data for the trained (squares) and the control (circles) groups on the Hearing Handicap Inventory for the Elderly or Adults (HHIE). The HHIE is a subjective measure of the subjects' handicap due to hearing loss. A lower score on the HHIE indicates that the subject perceives less hearing handicap.

FIG. 2B illustrates the average subject performance data for the trained (squares) and the control (circles) groups on the Communication Scale for Older Adults Attitudes (CSOA-a). The CSOA-a is a subjective measure of the subjects' attitudes. A lower score on this test indicates better attitudes regarding hearing loss.

FIG. 2C illustrates the average subject performance data for the trained (squares) and the control (circles) groups on the Communication Scale for Older Adults Strategies (CSOA-s). The CSOA-s is a subjective measure of the subjects' strategies. A lower score on this test indicates better strategies regarding hearing loss utilized in daily life.

FIGS. 3A through 3E illustrate responses by the trained group to survey questions regarding the subjects' impressions about the testing and results. The survey results confirmed the fact that methods disclosed herein are an efficacious and effective method for providing training.

FIG. 3A illustrates the responses to the question: was the software convenient and easy to use? FIG. 3B illustrates the responses to the question: would you recommend the methods used herein to a friend or family member? FIG. 3C illustrates the responses to the question: are you more likely to enter difficult listening situations? FIG. 3D illustrates the responses to the question: are you more confident in conversations? FIG. 3E illustrates the responses to the question: did you feel you were doing better, worse or was there no change during the training?

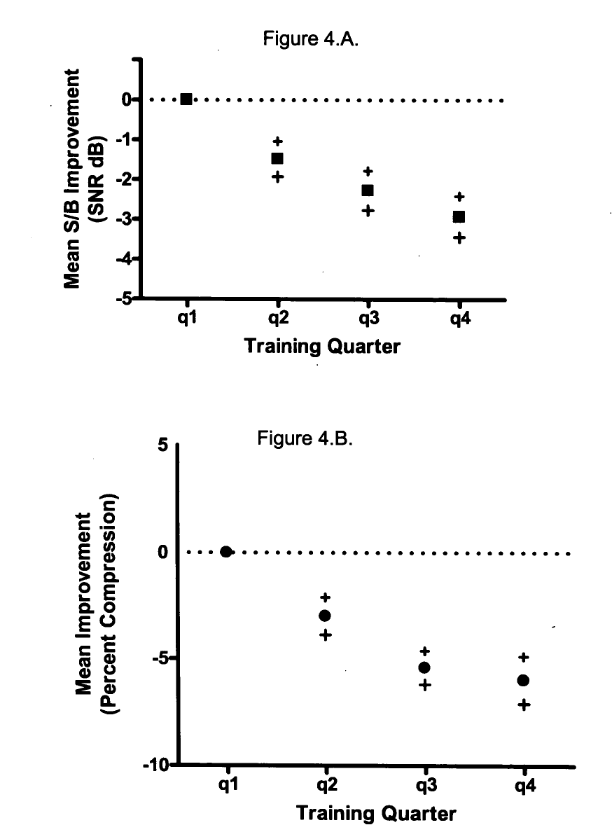

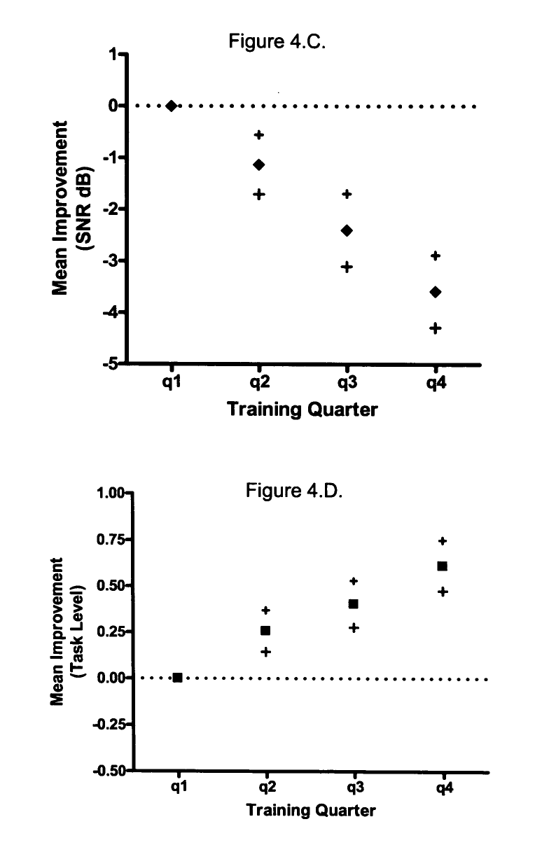

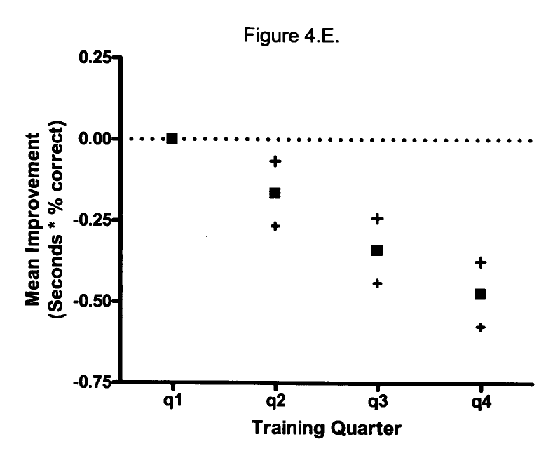

The performance data shown in FIGS. 4A through 4E were collected from the subjects at a baseline session (q1) and at three sessions (q2, q3 and q4) following the baseline session. The time between each session was one week. FIGS. 4A through 4E illustrate average improvement scores for the trained subjects on the training tasks. Average scores are indicated for each quarter of the training, with the standard error noted by crosshatches. All tasks showed significant improvement by the 3^{rd} quarter of training.

A decrease in score on the Speech in Noise (e.g., Babble) (S/B, shown in FIG. 4A), Time Compressed Speech (TC, shown in FIG. 4B), Competing Speaker (CS, shown in FIG. 4C) and the Missing Word (MW, shown in FIG. 4E) modules indicate improvement in the subject's hearing. A higher score on the Target Word module (TW, shown in FIG. 4D) indicates improvement in the subject's hearing. The dotted line indicates no change in score. The plus signs illustrate the range of the standard error of measurement (SEM). The squares illustrate the data points. Data is shown for each session.

FIG. 4A illustrates the improvement of the average subject's ability to distinguish speech in noise, with the speech to noise ratio in decibels. FIG. 4B illustrates the improvement of the average subject's time compression of time compressed speech. FIG. 4C illustrates the improvement of the average subject's ability to understand one of competing speakers, with the speech to noise ratio in decibels. The noise was the competing, not the desired, speech. FIG. 4D illustrates the improvement of the average subject's task level for determining the target word in the Target Word module. FIG. 4E illustrates the improvement of the average subject's time for performing the Missing Word module.

It is apparent to one skilled in the art that various changes and modifications can be made to the disclosure of the modules, and equivalents employed. For example, audibly playing data to a subject can also be performed by silently visually displaying the data, or by a combination of audibly playing the data and visually displaying the data. Elements shown with any module embodiment or module combination embodiment are exemplary for the specific embodiment and can be used on other embodiments within this disclosure.

Examples of the hardware platforms, and examples of devices, systems and methods for providing diagnosis and therapy for audiological diseases are described herein. The modules and methods disclosed supra can be performed by the systems and devices disclosed herein.

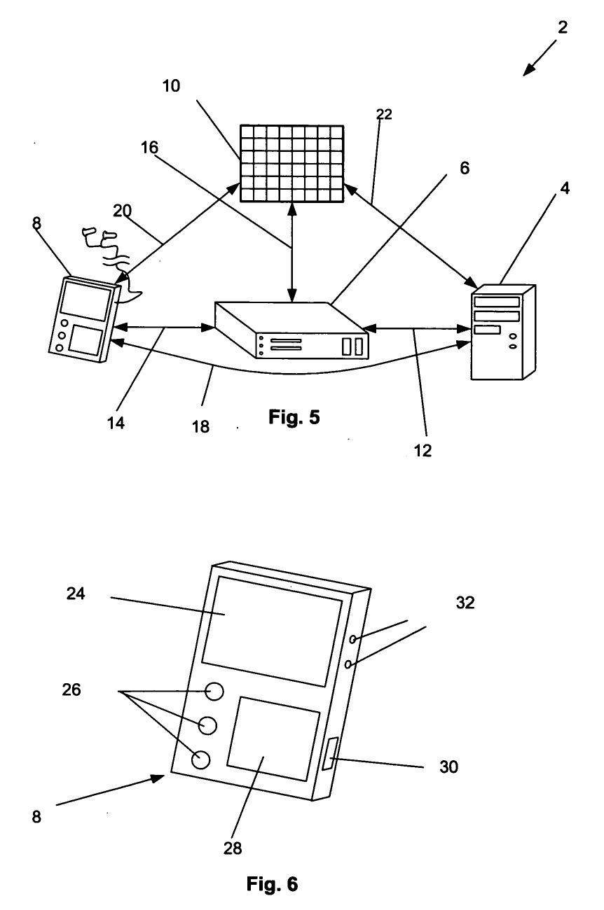

FIG. 5 illustrates a neurological treatment system 2. The treatment herein can include augmentation and/or diagnosis and/or therapy. The condition that can be treated can be any neurological process amenable to treatment or augmentation by sound, for example otological or audiological disorders such as hearing loss or other pathologies where retraining of the auditory cortex using auditory stimulus and/or training protocols to improve function is possible. Other examples of treatment of audiological conditions include refining or training substantially physiologically normal hearing, stuttering, autism or combinations thereof.

The system 2 can have a physician's device 4, a remote device 6, a local device 8 and a database 10. The physician's device 4 can be configured to communicate, shown by arrows 12, with the remote device 6. The remote device 6 can be configured to communicate with the local device 8, shown by arrows 14. The remote device 6 can be configured to communicate, shown by arrows 16, with the database 10. The physician's device 4 can be configured to communicate directly, shown by arrows 18, with the local device 8. The database 10 can be configured to communicate directly, shown respectively by arrows 20 and 22, with the local device 8 and/or the physician's device 4.

The physician's device 4, the remote device 6 and the local device 8 can be, for example, laptop or desktop personal computers (PCs), personal data assistants (PDAs), network servers, portable (e.g., cellular, cordless) telephones, portable audio players and recorders (e.g., mp3 players, voice recorders), car or home audio equipment, or combinations thereof. The physician's device 4, the remote device 6 and the local device 8 can be processors connected on the same circuit board, components of the same processor, or combinations thereof and/or combinations with the examples herein. The physician's device 4, the remote device 6 and the local device 8, or any combination thereof, can be a single device of any example listed herein, for example a single PC or a single, integrated processor.

The database 10 can be structured file formats, relational (e.g., Structured Query Language types, such as SQL, SQL1 and SQL2), object-oriented (e.g., Object Data Management Group standard types, such as ODMG-1.0 and ODMG-2.0), object-relational (e.g., SQL3), or multiple databases 10 of one or multiple types. The database 10 can be a single set of data. The database 10 can be or comprise one or more functions. The database 10 can be stored on the remote device 6. The database 10 can be stored other than on the remote device 6.

The communications can be via hardwiring (e.g., between two processors or integrated circuit devices on a circuit board), transferable media (e.g., CD, floppy disk, removable flash memory device, SIM card, a smart card, USB based mass storage device), networked connection (e.g., over the internet, Ethernet (IEEE 802.3), universal serial bus (USB), Firewire (IEEE 1394), 802.11 (wireless LAN), Bluetooth, cellular communication modem), direct point-to-point connection (e.g., serial port (RS-232, RS-485), parallel port (IEEE 1284), Fiber Channel, IRDA infrared data port, modem, radio such as 900 MHz RF or FM signal) or combinations thereof. The communications can be constant or sporadic.

The physician's device 4 can have local memory. The memory can be non-volatile, for example a hard drive or non-volatile semiconductor memory (e.g., flash, ferromagnetic). A copy of all or part of the database 10 can be on the local memory of the physician's device 4. The physician's device 4 can be configured to communicate with the database 10 through the remote device 6.

The remote device 6 can be configured to transfer data to and from the physician's device 4, the local device 8 and/or the database 10. The data transfer can be through a port (e.g., USB, Firewire, serial, parallel, Ethernet), a media player and/or recorder (e.g., CD drive, floppy disk drive, smart card reader/writer, SIM card, flash memory card reader/writer (e.g., Compact Flash, SD, Memory Stick, Smart Media, MMC), USB based mass storage device), a radio (e.g., Bluetooth, 802.11, cellular or cordless telephone, or radio operating at frequencies and modulations such as 900 Mhz or commercial FM signals) or combinations thereof.

Data stored in the database 10 can include all or any combination of the data found in patient profiles, profile assessment data 78, relevant assessment data 82, execution therapy reports, recommended therapy reports 90, physician's therapy reports, executed session reports 100 and analyzed session reports 114, several described herein. The reports can be compressed and decompressed and/or encrypted and decrypted at any point during the methods described herein. The reports can be script, XML, binary, executable object, text files and composites of combinations thereof.

FIG. 6 illustrates the local device 8. The local device 8 can be portable. The local device 8 can be less than about 0.9 kg (2 lbs.), more narrowly less than about 0.5 kg (1 lbs.), yet more narrowly less than about 0.2 kg (0.4 lbs.), for example about 0.17 kg (0.37 lbs.). For example, the local device 8 can be a graphic user interface (GUI) operating system (OS) PDA (e.g., the Yopy 500 from G.Mate, Inc., Kyounggi-Do, Korea).

The local device 8 can receive power from an external power source, for example a substantially unlimited power supply such as a public electric utility. The local device 8 can have a local power source. The local power source can be one or more batteries, for example rechargeable batteries, photovoltaic transducers, or fuel cells (e.g., hydrocarbon cells such as methanol cells, hydrogen cells). The local device 8 can be configured to optimize power consumption for audio output.

Power consumption can be reduced by placing sub-systems that are not in use into a low power state (e.g., sleep). Power consumption can be reduced by placing sub-systems that are not in use into a no power state (e.g., off). Power consumption can be reduced by dynamically changing the frequency of the clock governing one or more sub-systems.

Power consumption can be reduced by the inclusion of a specialized sound generation/playback integrated circuit. The specialized sound generation/playback integrated circuit can generate the therapeutic sounds through direct generation of the therapeutic sounds and/or can playback stored therapeutic sound. Power consumption of the specialized sound generation/playback integrated circuit can be substantially lower than other processing elements within the local device 8. During operation of the specialized sound generation/playback integrated circuit the other processing elements of the device can be placed into a low power or no power state. The power consumption reduction methods supra can be used individually or in any combination.

The local device 8 can have local memory, for example flash memory. The amount of local memory can be from about 64 KB to about 128 MB, more narrowly from about 1 MB to about 32 MB, yet more narrowly from about 4 MB to about 16 MB. The local device 8 can have a processor. The processor can have, for example, a clock speed equal to or greater than about 16 MHz, more narrowly equal to or greater than about 66 MHz. The local memory can be a portion of a larger memory device. The local device 8 can have random access memory (RAM) for the treatment available to the processor. The amount of RAM for the treatment can be equal to or greater than about 4 MB, more narrowly equal to or greater than about 32 MB. The RAM for the treatment can be a portion of a larger a quantity of RAM available to the processor. The local device 8 can have a real-time clock. The clock, for example a real-time clock, can be used to time stamp (i.e., couple with temporal data) any data within the local device 8. Data that can be time stamped can include data from any reports or transmission of any report or data, such as for reports pertaining to therapy sessions and conditions. Time stamp data can include relative or absolute time data, such as year, calendar date, time of day, time zone, length of operation data and combinations thereof.

The local device 8 can have a visual screen 24. The visual screen 24 can be a visual output and/or input, for example a transparent touch-pad in front of a display. The visual output can be a liquid crystal display (LCD) including an organic LCD, cathode ray tube, plasma screen or combinations thereof. The local device 8 can have user controls 26. The user controls 26 can be knobs, switches, buttons, slides, touchpads, keyboards, trackballs, mice, joysticks or combinations thereof. The user controls 26 can be configured to control volume, provide feedback (e.g., qualitative ranking, such as a numerical score, text or speech messages to physician), control the treatment, change treatment modes, set local device 8 parameters (e.g., day, month, year, sensor input parameters, default settings), turn local device 8 on or off, initiate communication and or synchronization with remote device 6, initiate communication and or synchronization with the physician's device 4 or combinations thereof

The local device 8 can have one or more external transducers 28. The external transducers 28 can be audio transducers 156, for example speakers and/or microphones. The external transducers 28 can sense ambient conditions (e.g., noise/sound, temperature, humidity, light, galvanic skin response, heart rate, respiration, EEG, auditory event-related potentials (ERP)) and/or be used to record verbal notes. The external transducers 28 can emit sound. The local device 8 can store in the local device 8's memory signals detected by the sensors and transducers of the local device 8. The sensor and transducer data can be stored with time stamp data.

The local device 8 can have a data transfer device 30. The data transfer device 30 can be a port (e.g., USB, Firewire, serial, parallel, Ethernet), a transferable storage media reader/writer (e.g., CD drive, floppy disk drive, hard disk drive, smart card, SIM card, flash memory card (e.g., Compact Flash, SD, Memory Stick, Smart Media, MMC), USB based mass storage device), a radio (e.g., Bluetooth, 802.11, cellular or cordless telephone, or radio operating at frequencies and modulations such as 900 Mhz or commercial FM signal) or combinations thereof. The data transfer device 30 can facilitate communication with the remote device 6.

The local device 8 can have one or more local device connectors 32. The local device connectors 32 can be plugs and/or outlets known to one having ordinary skill in the art. The local device connectors 32 can be cords extending from the local device 8. The cords can terminate attached to plugs and/or outlets known to one having ordinary skill in the art. The local device connectors 32 can be media players/recorders (e.g., CD drive, floppy disk drive, hard drive, smart card reader, SIM card, flash memory card, USB based mass storage device). The local device connectors 32 can be radio (e.g., Bluetooth, 802.11, radio, cordless or cellular telephone).

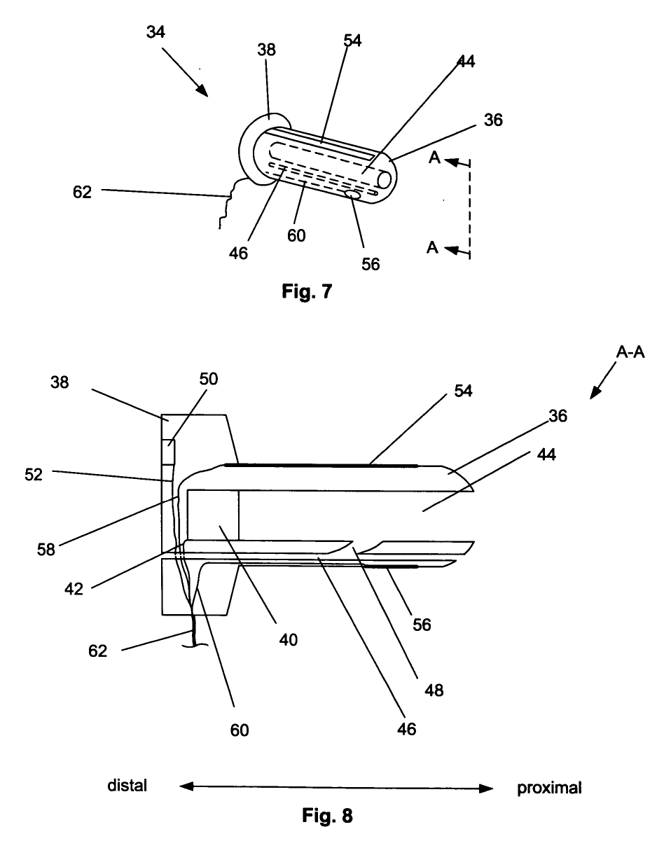

The local device 8 can have one, two or more earpieces 34. The local device connectors 32 can facilitate communication with the earpiece 34. FIG. 7 illustrates the earpiece 34 that can have a probe 36 attached to a retention element 38. FIG. 8 illustrates cross-section A-A of the earpiece 34 of FIG. 7. The probe 36 can be shaped to fit intra-aurally. The earpiece 34 can be shaped to fit entirely supra-aurally. All or part of the retention element 38 can be shaped to fit in the intertragic notch. The retention element 38 can be shaped to fit circumaurally. The retention element 38 can be padded. The probe 36 and/or the retention element 38 can be molded to fit the specific ear canal and intertragic notch for a specific patient.

The earpiece 34 can have a therapy transducer 40. The therapy transducer 40 can be an acoustic transducer, for example a headphone speaker. A therapy lead 42 can extend from the therapy transducer 40.

An acoustic channel 44 can extend from the therapy transducer 40 to the proximal end of the probe 36. The earpiece 34 can have an ambient channel 46 from the distal end of the earpiece 34 to the proximal end of the earpiece 34. The ambient channel 46 can merge, as shown at 48, with the acoustic channel 44. The ambient channel 46 can improve transmission of ambient sound, humidity and temperature through the earpiece 34. The ambient channel 46 can be a channel from the distal end to the outside and/or proximal end of the earpiece 34.

The earpiece 34 can have one or more ambient conditions sensors 50. The ambient conditions sensors 50 can sense ambient sound frequency and/or amplitude, temperature, light frequency and/or amplitude, humidity or combinations thereof. An ambient lead 52 can extend from the ambient conditions sensor 50.

The earpiece 34 can have one or more biometric sensors, such as biometric sensor strip 54s and/or biometric sensor pads 56. The biometric sensors can be configured to sense body temperature, pulse (i.e., heart rate), perspiration (e.g., by galvanic skin response or electrodermal response), diastolic, systolic or average blood pressure, electrocardiogram (EKG), brain signals (e.g., EEG, such as EEG used to determine sensory threshold audio levels, auditory event-related potentials (ERP)), hematocrit, respiration, movement and/or other measures of activity level, blood oxygen saturation and combinations thereof. The biometric sensors can be electrodes, pressure transducers, bimetallic or thermister temperature sensors, optical biometric sensors, or any combination thereof. An example of optical biometric sensors is taught in U.S. Pat. No. 6,556,852 to Schulze et al., which is hereby incorporated by reference in its entirety. A strip lead can extend from the biometric sensor strip 54. A pad lead 60 can extend from the biometric sensor pad 56.

The leads can each be one or-more wires. The leads can carry power and signals to and from their respective transducer and sensors.

The leads can attach to an earpiece connector 62. The earpiece connector 62 can be one or more cords extending from the earpiece 34. The cords can terminate attached to plugs and/or outlets (not shown) known to one having ordinary skill in the art. The earpiece connector 62 can be a plug and/or an outlet known to one having ordinary skill in the art. The earpiece connector 62 can be a media player/recorder (e.g., CD drive, flash memory card, SIM card, smart card reader). The earpiece connector 62 can be a processor and/or a radio (e.g., Bluetooth, 802.11, cellular telephone, radio). The earpiece connector 62 can connect to the local device 8 connector during use.

Methods of Treatment

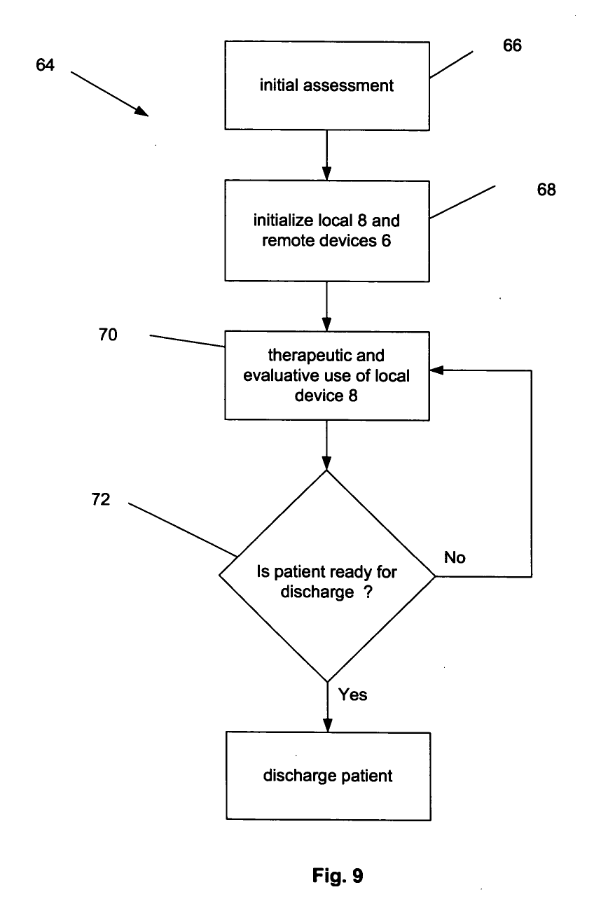

FIG. 9 illustrates a method of treatment 64, such as a neurological or audiological treatment. (For exemplary clarity the treatment is referred to hereafter, non-limitingly, as the audiological treatment.) An initial assessment 66 of an audiological disorder, such as hearing loss, tinnitus, or any other audiological disorder in need of rehabilitation, can be made, for example by a physician during a visit with a patient. The local and remote devices 6 can then be initialized 68. The local device 8 can then be used 70 for evaluation and/or therapy. After use, if the patient is not ready to be discharged from therapy, the query as shown by 72, using the local device 8 for diagnosis or re-evaluation and therapy can be repeated. After use, if the patient is ready to be discharged from therapy, the patient can be discharged from the treatment.

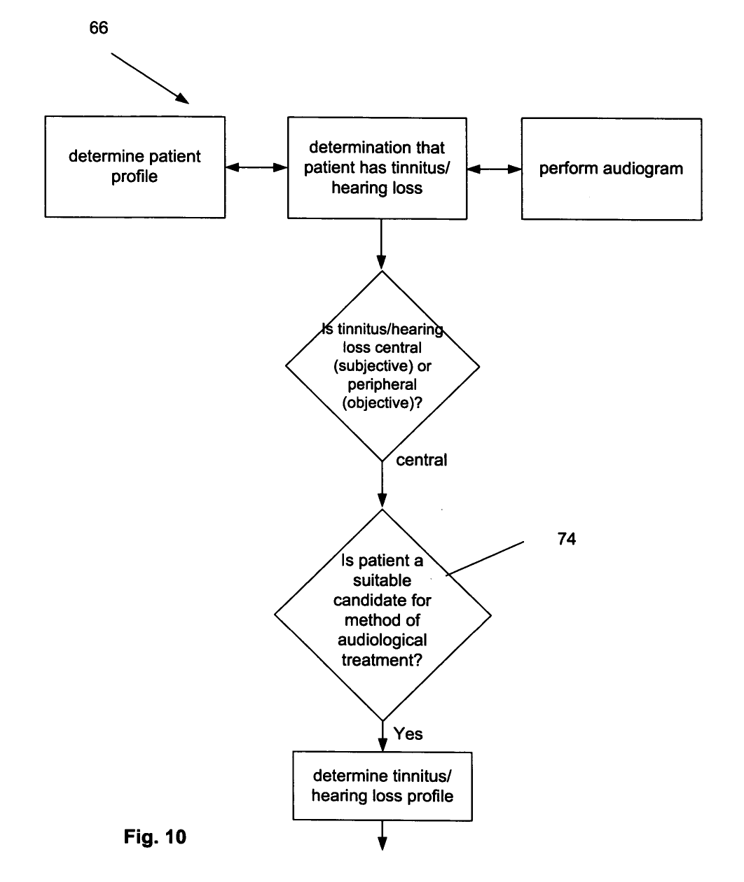

FIG. 10 illustrates making the initial assessment 66 of an audiological disorder. The physician can determine that the patient has the audiological disorder, such as sensorineural hearing loss or tinnitus. (For exemplary clarity the audiological disorder is referred to hereafter, non-limitingly, as hearing loss.) The physician can perform an audiogram on the patient before or after the determination of hearing loss. The physician can determine the patient profile (e.g., gender, age, career, existing and cured health problems, allergies, biometrics such as blood pressure and temperature, stress, exertion, tension, presence of noise, rest, insurance company and policy, length of time of affliction, precipitating event), for example, from the combination of a pre-existing file and/or an interview and/or exam. The physician can determine whether the hearing loss is central (i.e., subjective) or peripheral (i.e., objective). If the hearing loss is central (or the other neurological disorder can be corrected by sound therapy), the patient can be analyzed, as shown by 74, to determine if the patient is a suitable candidate for the method of audiological treatment. If the patient is a suitable candidate for therapy, the audiological treatment can proceed to the initialization of the local and remote devices 6.

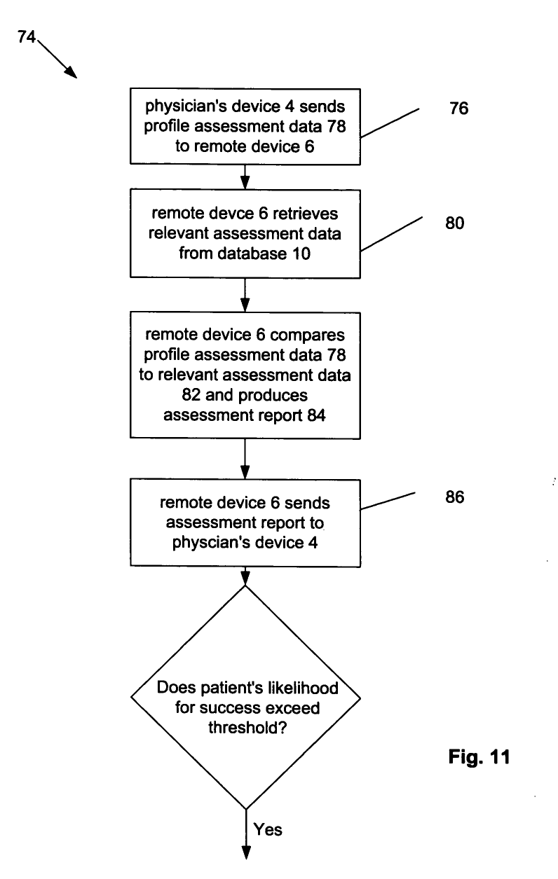

The patient's hearing loss profile can be determined after the physician has determined that the patient has hearing loss. The hearing loss profile can include the symptom tones (e.g., tones lost for hearing loss or tones heard during tinnitus) and the respective amplitudes for each tone. The hearing loss profile can include tones for which the patient has partial or total hearing loss, the degree of hearing loss at each of the tones, an objectively and/or subjectively determined impairment score or combinations thereof. FIG. 11 illustrates, as shown, determining whether the patient is a suitable candidate for treatment by the method of treatment 64.

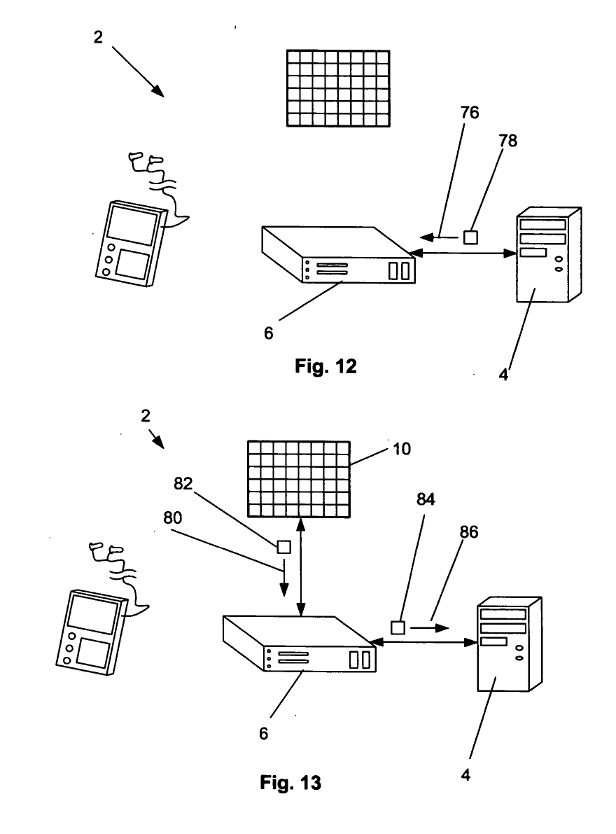

As shown in FIG. 12, the physician's device 4 can send, shown by arrow 76, profile assessment data 78 to the remote device 6. The profile assessment data 78 can be all or part of the patient profile, hearing loss profile, additional hearing tests or any combination thereof.

As shown in FIG. 13, the remote device 6 can retrieve, as shown by arrow 80, relevant assessment data 82 from the database 10. The relevant assessment data 82 can include data from patients with similar profile assessment data 78. The relevant assessment data 82 can include profile assessment data 78, treatment efficacy, treatment protocols, summaries of any of the aforementioned data (e.g., as single or multi-dimensional indices) and combinations thereof. The remote device 6 can compare the profile assessment data 78 to the relevant assessment data 82. This comparison can, for example, determine the optimal treatment protocol for the patient. The comparison can be performed with static and/or modeling techniques (e.g., data-mining).

For example, the profile assessment data 78 can be compared to the relevant assessment data 82 and the best matches of pretreatment conditions can be determined therefrom. Of the successful matches, the treatment protocols used to generate successful outcomes (e.g., results above a threshold level) can be assessed and averaged. This average can be used to derive an assessment report 84.

The remote device 6 can then produce the assessment report 84 and send, shown by arrow 86, the assessment report 84 to the physician's device 4, as shown in FIG. 13. The remote device 6 can send the assessment report 84 to a third party, for example, an insurance company. The assessment report 84 can be printed and sent as a hard copy, or sent as a file via an e-mail, file transfer protocol (FTP), hypertext transfer protocol (HTTP), HTTP secure (HTTPS) or combinations thereof. The assessment report 84 can be encrypted. The assessment report 84 can be compressed.

The assessment report 84 can include the assessment data, a likelihood of patient success, a threshold success level for the patient, a recommendation regarding whether the patient's likelihood exceeds the patient's threshold success level, a prognosis, an initial recommended therapy report 90, graphs of all collected data comparing the patient to similar patients, case examples of similarly assessed patients or combinations thereof. Therapy reports can include a protocol or prescription for administering sound therapy sessions. The protocol can include one or more sounds, such as therapeutic audio. The sounds can include one or more tones, gains and/or amplitudes for each tone, one or more noise profiles (e.g., the shape of the power spectrum), music, mechanical representation of the determined audio treatment information, overall gains and/or amplitudes for each noise profile, other sounds (e.g., buzzes, swirling, modulated tones, pulses) and their respective overall gains and/or amplitudes, a therapy schedule, recommended re-evaluation dates and/or times, and combinations thereof.

The therapy schedule can include when (e.g., dates and/or times) each tone and/or noise is to be played, how long each tone and/or noise is to be played, instructions for the patient and/or the system 2 regarding what to do if a therapy is missed.

The therapy report can be a script, XML, binary, executable object, text file and composites of combinations thereof. The therapy report can be encrypted. The therapy report can be compressed.

The threshold success level for the patient can be assigned a value by the patient's insurance company. The threshold success level can be assigned a value based on normative database 10 averages. The threshold success level can be assigned a value by the physician. The physician can then determine whether the patient's likelihood for success exceeds the threshold success level for the patient. The physician can overrule the remote device's recommendation of whether the patient's likelihood for success exceeds the patient's threshold success level. If the physician determines to continue with the method of audiological treatment, the local and remote devices 6 can be initialized.

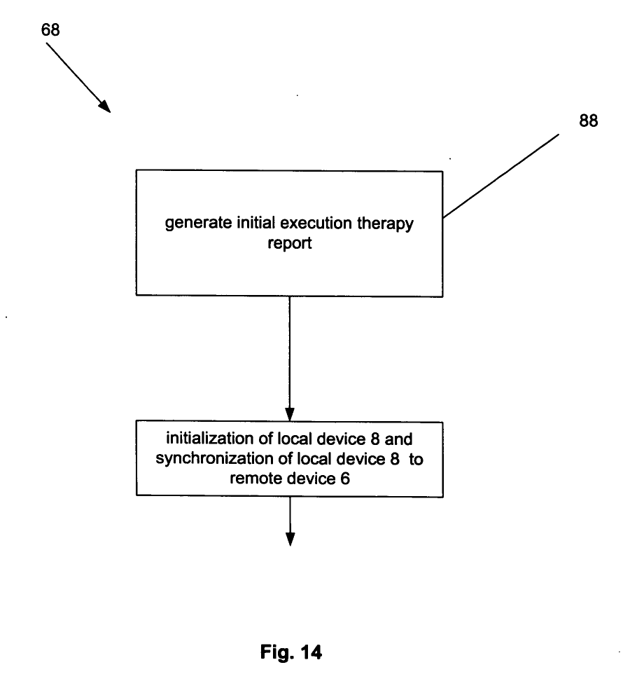

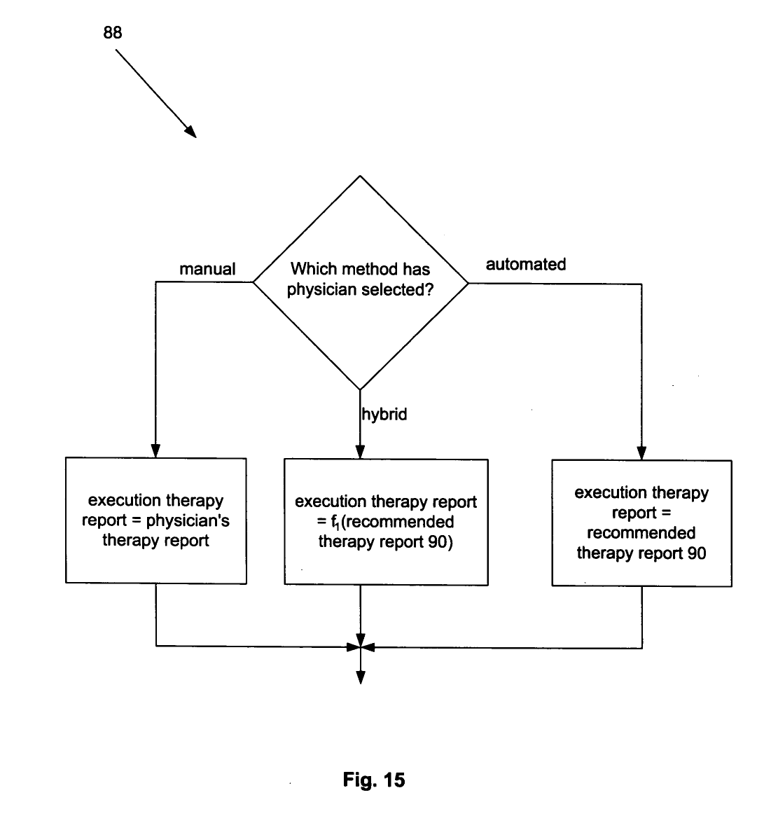

FIG. 14 illustrates the initialization of the local and remote devices 6. An initial execution therapy report can be generated, as shown by 88, for example, by using the recommended therapy report 90 from the assessment report 84 and/or using a physician's therapy report from the physician. The execution therapy report can contain the therapy report that will be executed by the local device 8.

The physician's therapy report can include the physician's selection as to present and future methods of generating the execution therapy report. The execution therapy report can be entirely copied from the physician's therapy report (i.e., a manual selection), entirely copied from the recommended therapy report 90 (i.e., an automated selection), or generated by the remote device 6 as a function of the recommended therapy report 90 and the physician's therapy report (i.e., a hybrid selection).

FIG. 15 illustrates a method for generating the initial execution therapy report. If the physician's therapy report has a manual selection, the execution therapy report can be copied from the physician's therapy report.

If the physician's therapy report has an automated or default selection, the execution therapy report can be copied from the recommended therapy report 90.

If the physician's therapy report has a hybrid selection, the physician's therapy report and the recommended therapy report 90 can be processed by a function (f₁) that results in the execution therapy report. That function can be generated, by the physician modifying any of the data in the recommended therapy report 90. For example, the physician can modify the recommended therapy report 90 to include additional scheduled treatment sessions.

The local device 8 can be initialized by deleting prior patient information from the memory of the local device 8 and restoring the settings to a default state. The local device 8 can then be synchronized to the remote device 6 as described herein.

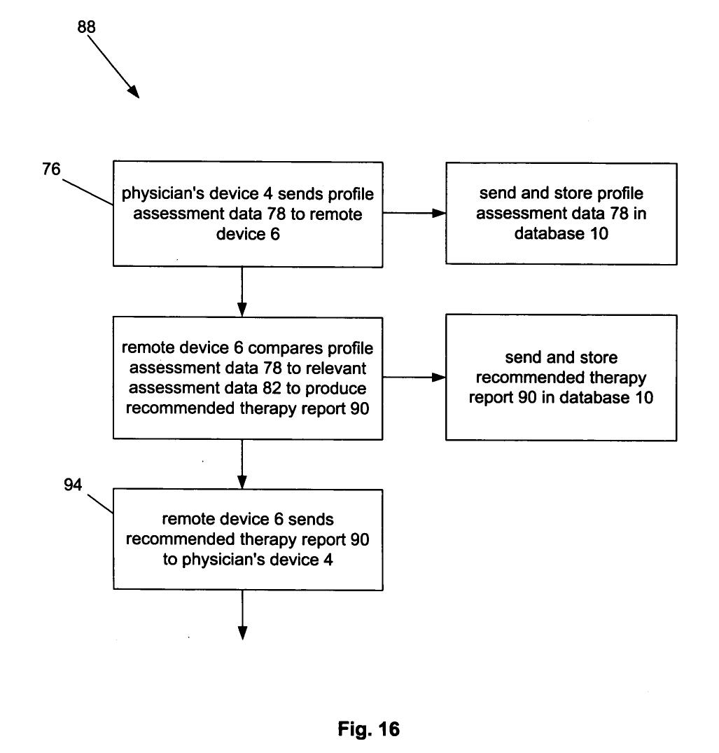

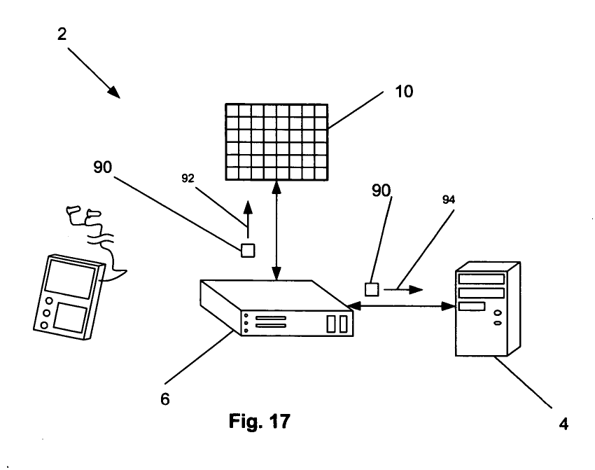

FIG. 16 illustrates generating the recommended therapy report 90. The physician's device 4 can send the profile assessment data 78 to the remote device 6, as shown in FIG. 16. As shown by arrow 92, the remote device 6 can send and store (not shown) the profile assessment data 78 in the database 10.

The remote device 6 can then compare the profile assessment data 78 to the relevant assessment data 82 to produce a recommended therapy report 90. For example, the remote device 6 can identify that the volume level for the perceived hearing loss tone has decreased as a result of treatment, and consequently modify the volume in the recommended therapy report 90.

The remote device 6 can send and store the initial recommended therapy report 90 in the database 10, as shown in FIG. 17. The remote device 6 can send, as shown by arrow 94, the initial recommended therapy report 90 to the physician's device 4. The remote device 6 can send the initial recommended therapy report 90 to a third party, for example, an insurance company or health monitoring organization.

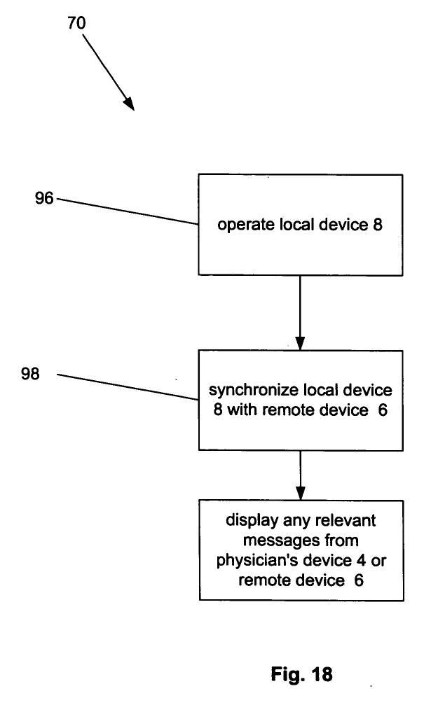

FIG. 18 illustrates, as shown by 96, evaluation and therapeutic use of the local device 8. The local device 8 can be operated, shown by 96, for example by the patient on the patient. The local device 8 can then be synchronized, shown by 98, with the remote device 6. The local device 8 can display or play any messages from the remote device 6 or the physician for the patient to read or hear.

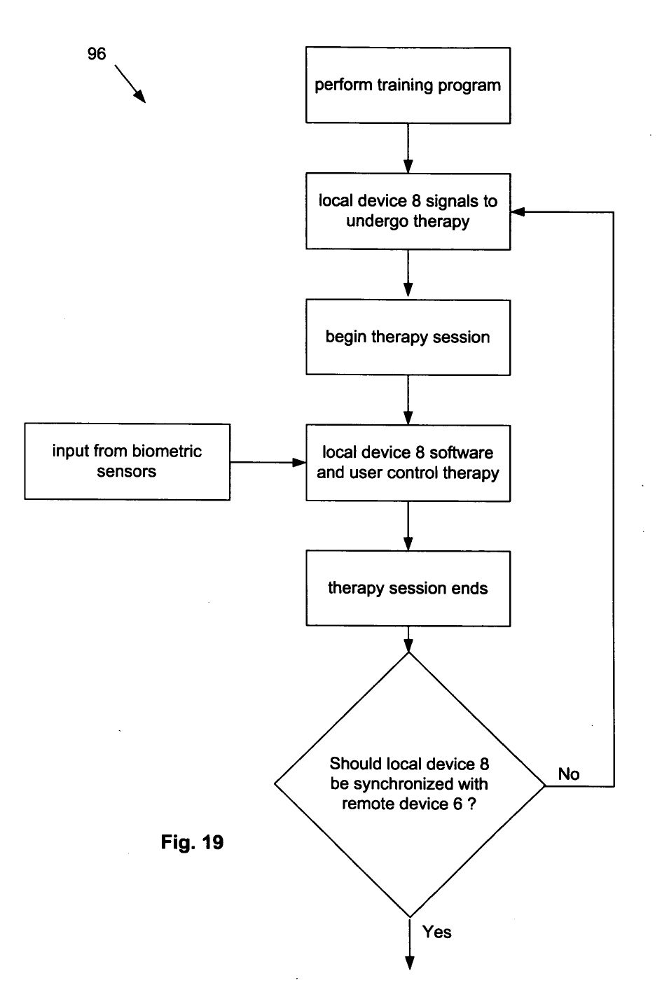

FIG. 19 illustrates operation of the local device 8. A training program on the local device 8 can be performed, for example by the patient. The training program can orient and teach the user operation of the local device 8. The training program can teach the user the importance of proper use of the system 2.

The training program can be skipped by the user automatically or by the local device 8, for example after the first use. The ability to skip the training program can be inhibited by the physician as part of the execution therapy report.

When the therapy schedule of the execution therapy report calls for therapy, the local device 8 can signal the patient to undergo therapy. The signal can be audible, visual, vibratory or a combination thereof. The patient can then apply the local device 8. Application of the local device 8 can include placing the speaker close enough to be heard at the desired volume and/or wearing the earpiece 34. The sound therapy session can then begin. The patient can receive the sound therapy by listening to the sound therapy session. The listening can include listening over the on-board speaker (i.e., the external transducer 28) and/or listening through the earpieces 34 or other auxiliary speakers.

While delivering the sound therapy session, the local device 8 can be controlled by the software. The local device 8 can run the sound therapy session (e.g., schedule, tones, gain) as prescribed by the execution therapy report. The local device 8's software can adjust the volume based on the ambient noise level. The volume can be adjusted so that emitted sound can be appropriately perceived by the patient given the ambient noise level.

The local device's software can apply feedback from biometric sensors to the local device 8. For example, the patient's heart rate signal can be used as part of a biofeedback system to relax the patient while listening to the emitted sound.

The biometric sensors can be internal or external to the local device 8. The local device 8 can use the biometric values to determine the efficacy of the treatment and adjust the treatment during or between sessions based on the efficacy. The biometrics can be sensed and recorded by the local device 8. The biometrics can be constantly or occasionally sensed and displayed to the user during use of the local device 8. The user can be informed of the efficacy of the treatment. The user can attempt to consciously control the biometrics (e.g., slow the heart rate by consciously calming).

The local device's 8 software can play audio and/or visual messages from the physician's device 4 stored in the execution therapy report.

The patient can control the therapy. The patient can adjust the therapeutic amplitudes/gain and tones, for example with a mixer. The patient can also select a background sound to be delivered with the therapy session. Background sounds include music, nature sounds, vocals and combinations thereof. The user can select predefined modes for the local device 8. For example, the user can select a mode for when the user is sleeping (e.g., this mode can automatically reduce the sound amplitude after a given time has expired), a driving mode (e.g., this mode can play ambient noise with the sound therapy session, or set a maximum volume), a noisy mode, a quiet mode, an off mode or combinations thereof. The patient can remove the local device 8 from audible range, effectively stopping therapy. The local device 8 can record the therapy stoppage in the session report.

Patient feedback can be sent to the local device 8 during or after a therapy session. For example, the patient can provide a qualitative rating of the therapy (e.g., thumbs-up/thumbs-down, or on a ten-point scale), record verbal or text notes regarding the therapy into the memory of the local device 8 or combinations thereof. Any biometrics (e.g., as measured by the local device 8 or by another device) can be entered into memory of the local device 8, manually entered through the local device 8 if necessary. The feedback, biometric and/or non-biometric, can be time and date stamped.

As FIG. 19 illustrates, when the sound therapy session ends, the local device 8 can be synchronized with the remote device 6, as shown by 98. The remote device 6 or local device 8 can signal that the local device 8 should be synchronized with the remote device 6. The user can also synchronize the local device 8 without a signal to synchronize.

During use of the local device 8, the local device 8 can perform a sensory threshold test. The sensory threshold test can be initiated by the user or the local device 8. The sensory threshold test can be performed on a frequency (e.g., before every therapy session, every morning, once per week) assigned by the execution therapy report. 101481 During the sensory threshold test, the local device 8 can emit the user's hearing loss tones to the user. The local device 8 can then adjust the amplitude of the produced tones (e.g., trying higher and lower amplitudes, using the method of limits). The user can send feedback to the local device 8 regarding the user's ability to match the amplitudes of the user's natural hearing loss tones to the amplitudes of the local device 8-generated tones. The local device 8 can then store the resulting amplitudes in the executed session report 100. The user and/or the local device 8 can adjust the local device 8-generated tones individually (e.g., with a manually-controlled mixer on the local device 8 and/or to account for ambient sounds).

After a therapy session ends, the local device 8 can produce an executed session report 100. The executed session report 100 can include all executed session data that has occurred since the last synchronization between the local device 8 and the remote device 6. The session data can include the usage (e.g., number of times used, length of time used, time of day used, date used, volume at which it was used), patient feedback (e.g., qualitative rating of the therapy, verbal or text notes, biometric feedback or combinations thereof), prior therapy reports, including the immediately prior therapy report. Subjective feedback from the user can be solicited by the local device 8 by use of interactive entertainment (e.g., a game).

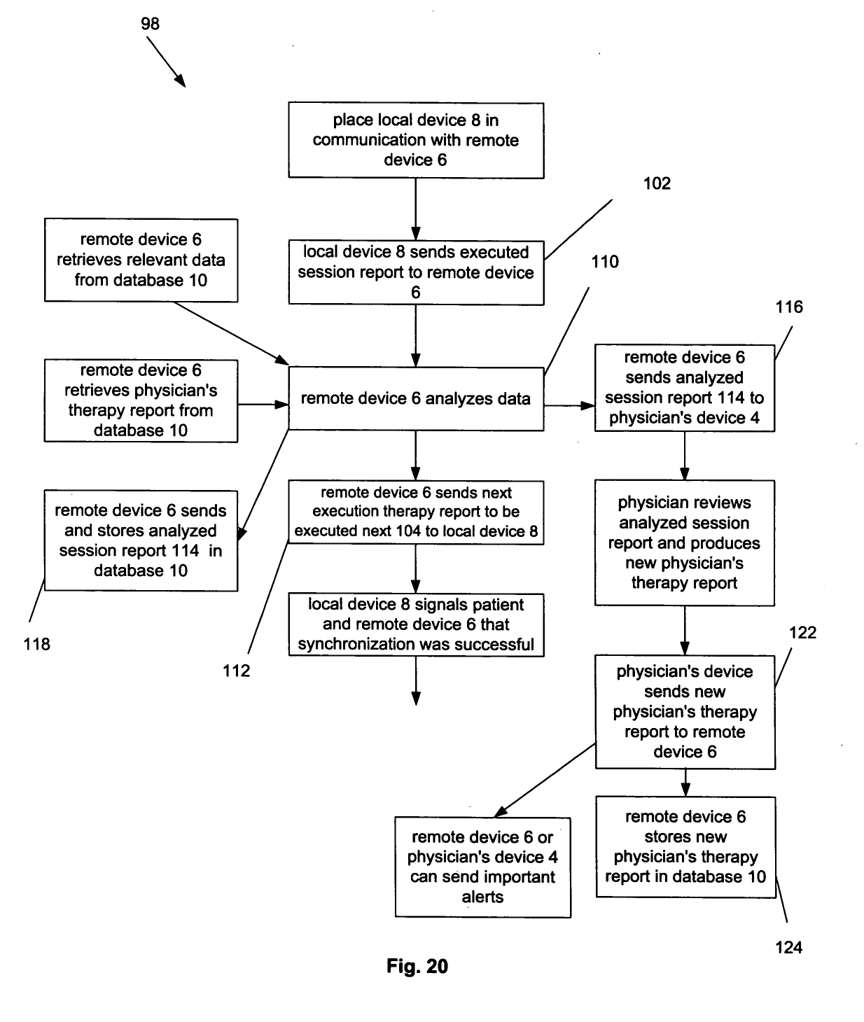

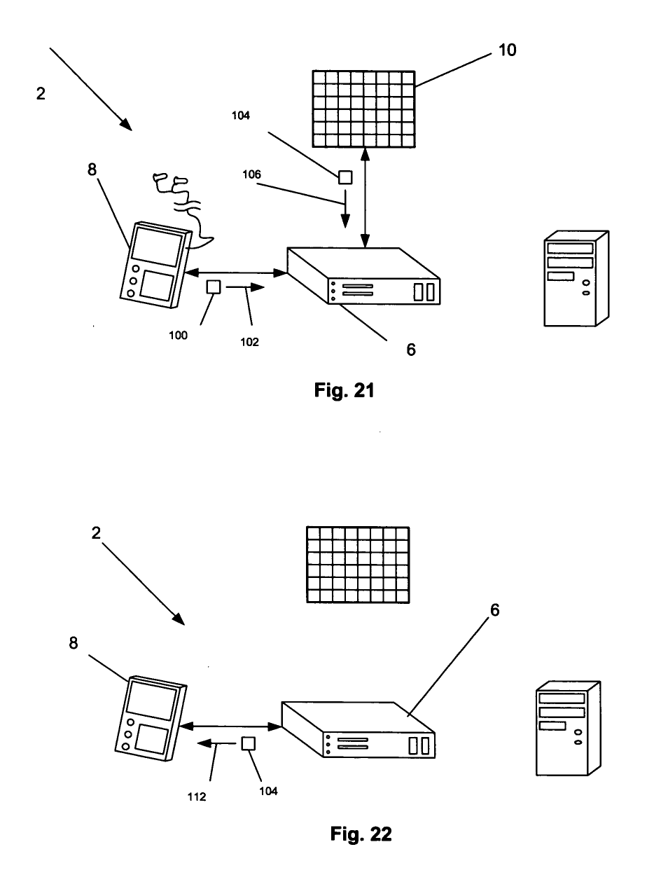

FIG. 20 illustrates that the local device 8 can be placed in communication with the remote device 6. The local device 8 can then send the executed session report 100 to the remote device 6, as shown by arrow 102 in FIG. 21. The executed session report 100 can be encrypted. The executed session report 100 can be compressed.

The remote device 6 can retrieve, as shown by 106, from the database 10 the execution therapy report to be executed next 104 by the local device 8, as shown in FIG. 21. As shown by 110, the remote device 6 can analyze the executed session report 100, the to-be-executed-next execution therapy report 104, and data from the database 10 (including data from the patient). The remote device 6 can produce an analyzed session report 114.

Statistical methods and algorithms can be used to compare expected patient progress with actual patient progress. Changes in the patient protocol can be generated, at least in-part, based on this analysis. Changes can include, for example, lengthening or shortening the amount of treatment time, changes in tone volume, recommendation for reevaluation.

The analyzed session report 114 can include the session data, an analysis including a new recommended therapy report 90. The new recommended therapy report 90 can be modified based, at least in-part, on the analysis of session data. For example, if the patient's progress is not as predicted or expected, the amplitude of the treatment tone can be increased, the duration of the treatment can be increased, a new treatment may be added or combinations thereof.

As shown in FIG. 20, the remote device 6 can analyze the recommended therapy report 90, the physician's therapy report and the analyzed session report 114 and produce a new execution therapy report. The new execution therapy report can include the same categories of data as the initial execution therapy report.

The remote device 6 can send the to-be-executed-next execution therapy report 104 to the local device 8, as shown by arrow 112 in FIG. 22. The local device 8 can signal to the patient and the remote device 6 that synchronization was successful. The success of the synchronization can be logged in the analyzed session report 114. The local device 8 can display any urgent messages.

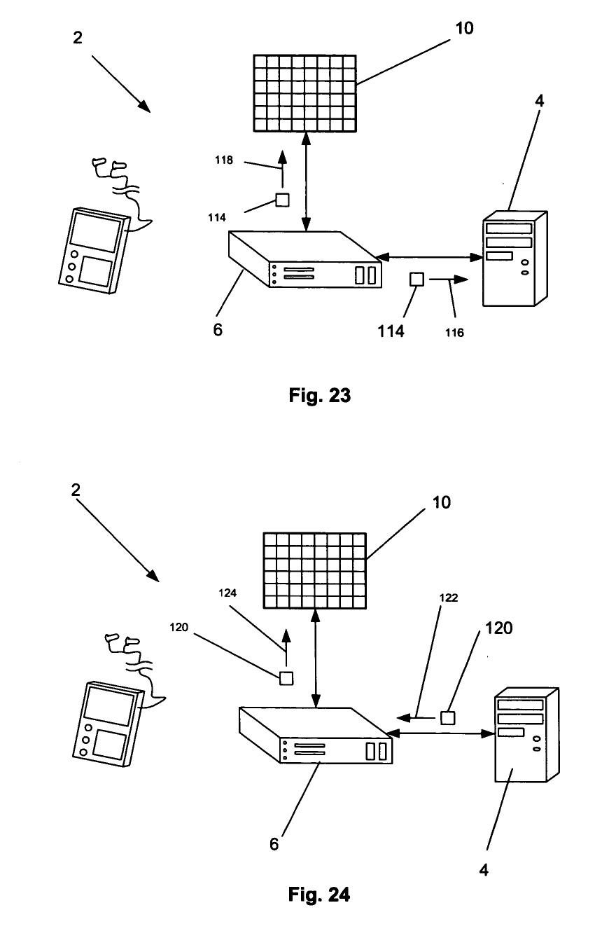

The remote device 6 can send and store the analyzed session report 114 in the database 10, as shown by arrow 118 in FIG. 23. The remote device 6 can send the analyzed session report 114 to the physician's device 4, as shown by arrow 116 in FIG. 23. The physician can review the analyzed session report 114 and produce a new physician's therapy report 120, if desired. If the physician produces a new physician's therapy report 120, the physician's device 4 can send the new physician's therapy report to the remote device 6, as shown by arrow 122 in FIG. 24. The remote device 6 can send urgent alerts to the physician's device 4 (i.e., including portable phones, pagers, facsimile machines, e-mail accounts), for example, by text messaging, fax, e-mail, paging or combinations thereof. The remote device 6 can send and store the new physician's therapy report in the database 10, as shown by arrow 124 in FIG. 24.

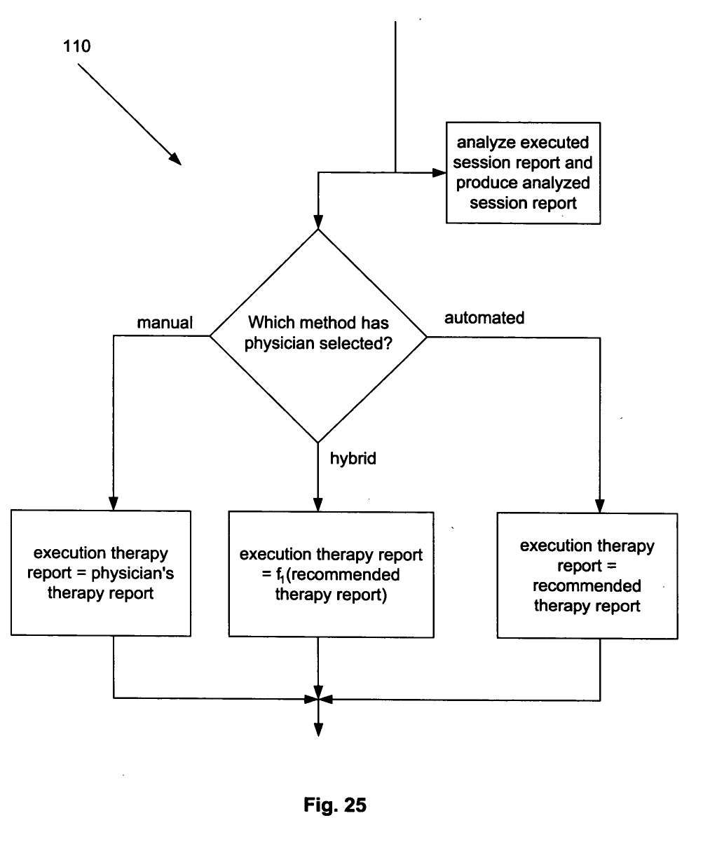

FIG. 25 illustrates analyzing the session report and the recommended and physician's therapy reports and producing the analyzed session report 114 and the execution therapy report, as shown in FIG. 20. The executed session report 100 can be analyzed and an analyzed session report 114 can be produced, as described herein. The execution therapy report can be produced as described herein, for example, in FIG. 15.

An Application Service Provider (ASP) can be used in conjunction with the system 2 and/or method. The ASP can enable any of the devices, the patient and/or the doctor, access over the Internet (e.g., by any of the devices) or by telephone to applications and related services regarding the system 2 and use thereof. For example, the ASP can perform or assist in performing the sensory threshold test. In another example, the ASP can include a forum where patients can pose questions or other comments to trained professionals and/or other patients. In yet another example, the ASP can monitor and analyze the database 10, and the ASP can make suggestions therefrom to physicians and/or health monitoring organizations.

Methods and parts of methods are disclosed herein as being performed on one device for exemplary purposes only. As understood by one having ordinary skill in the art with this disclosure, any method or part of a method can be performed on any device.

Hardware Interface

A hardware interface 126 can be equivalent to and/or be part of the remote device 6. The hardware interface 126 can have user controls 26, such as a series of buttons on the interface. The buttons can each perform a single or a small number of commands when depressed. Some or all of the buttons can have associated signals, for example LEDs. The signal can emit a particular signal to illustrate what buttons are available to be pressed by the subject. A single button can cause the device and/or system 2 to synchronize with a server. Each button can be large and spread sufficiently, for example to minimize errors, such as those by subjects with neurological degradation in their motor functions.

First Architecture

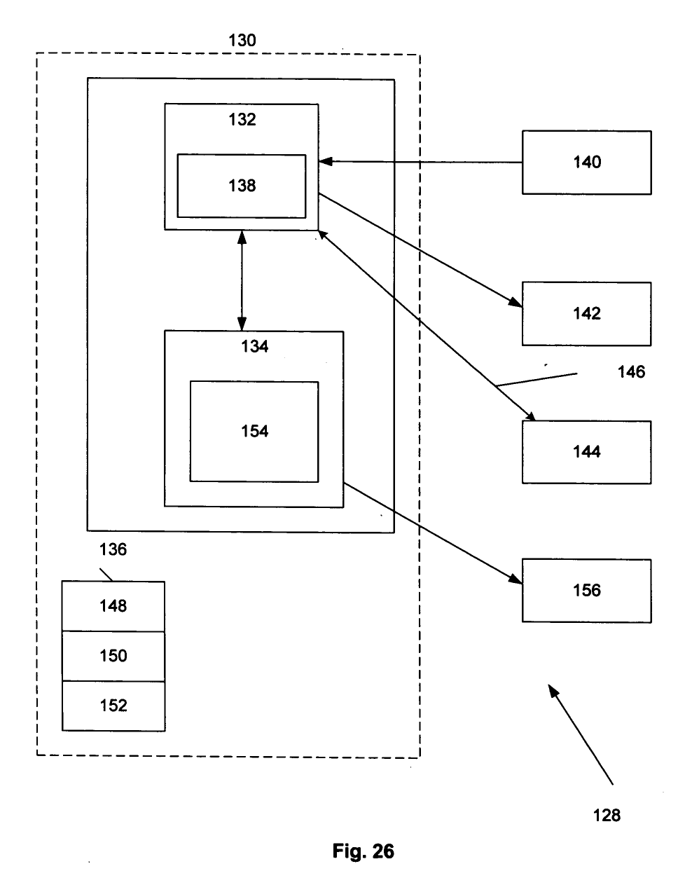

The first architecture 128 can be part of any of the devices and/or the database 10. FIG. 26 illustrates an embodiment of the hardware and/or software first architecture 128 for the neurological rehabilitation system 2. The first architecture 128 can have an on-board system 130. The on-board system 130 can be internal (i.e., on or in) or external to a single physical package (e.g., processor, chip), circuit board, or case. “On-board” refers to a fast data transfer capability between the elements of the on-board system 130. The on-board system 130 can have a module application 132, an audio engine 134 and, and embedded system 136. The module application 132 and the audio engine 134 can be part of the same application.

The module application 132 can process a software or hardware application that can execute one or more neurological (e.g., aural, comprehension, communication) rehabilitation modules. The module application 132 can have, or be integrated with, a graphical user interface (GUI) porting layer 138.

A buttons module 140 (i.e., a user control module), a display module 142 (i.e., a visual screen module), and a server system 144, can be on-board or not on-board (as shown). The module application 132 can receive data from the buttons module 140 (as shown). The buttons module 140 can receive input from the hardware interface 126, for example the buttons or other user controls 26 that the subject activates.

The buttons module 140 can have two-way data communication with the module application 132, for example to drive the hardware interface 126 for a demo program to instruct the subject how and when to mechanically use the interface.

The display module 142 can receive data from the module application 132. The display module 142 can drive a display (e.g., LCD, CRT, plasma). The display module 142 can have two-way communication with the display, for example for touch-screens. The buttons module 140 and the display module 142 can be combined for “touch” screens, or the buttons module 140 can act separately from the display module 142 for touch screens.

The server system 144 can include the physician's device 4, and/or the local device 8, and/or the database 10 as shown and described herein, for example in FIG. 5. The module application 132 and the server system 144 can synchronize, as shown by 146, and described by the local device 8 synchronizing with the remote device 6 shown and described herein.

The embedded system 136 can have an on-board operating system interface 148 (e.g., X11) and/or drivers 150 and/or kernels 152. The operating system interface 148, as shown, can be an operating system itself (e.g., Windows, UNIX, Mac OS), with or without an operating system interface 148. The operating system interface 148 can also be just the operating system interface 148 (e.g., X11) without the operating system, and the first architecture 128 can then be executed on an operating system.

Audio Engine

The audio engine 134 can have two-way (as shown) communication with the module application 132. The module application 132 can send commands to the audio engine 134 of desired audio output data (i.e., audio signal) to be created. The audio engine 134 can create the desired audio output data and deliver it to the module application 132 to then be delivered (not shown) to the audio transducers 156, or the audio engine 134 can deliver the audio output data directly to the audio transducers 156 (as shown). The audio engine 134 can report on the status of audio output data created and played to the module application 132.

The audio engine 134 can have an audio porting layer 154.

The audio engine 134 can have only one-way communication (not shown) with the audio engine 134, and the audio engine 134 can deliver the desired audio output directly to the audio transducers 156.

The audio engine 134 can receive an audio data set. The audio data set can be an audio file from a memory location on-board or not on-board, and/or in or not in the aural rehabilitation system 2. The audio data set can be an audio file from the module application 132. The audio data can be real-time audio input. The audio data set can be previously played audio output data.

The module application 132 and/or the audio engine 134 can process the audio data set to create the audio output data. The processing can include mixing the audio data with noise, time delaying, distorting such as time compressing, equalizing, echoing, modulating, volume changing such as fading in and/or fading out, pitch shifting, chorusing, flanging, increasing and/or decreasing sample rate, reverberating, sustaining, shifting from one-channel to another such as panning, high-pass and/or low-pass and/or band-pass filtering, otherwise altering as needed by the module, or combinations thereof.

On the fly or real time is defined as being performed in the present, near future or concurrent with or substantially immediately following other critical operations, such as computing a subject's score. The module application 132 and/or the audio engine 134 can process the audio data set on the fly.

The processing can be based on the subject's input data. The input data received by the module application 132, such as from the buttons module 140, can be sent, processed or unprocessed, to the audio engine 134. Based on the input data from a first playing of the audio output data, the processing of the audio output data can be increased, decreased, and or reversed with the magnitude being increased or decreased. The newly processed audio output data can then be played to the subject, and new subject's input data can be received based on the newly played audio output data.

For example, the system 2 can play audio output data that is 60% audio data set, such as sound (e.g., speech), and 40% noise to the subject. The subject can enter input data into the system 2 that the subject does not understand the sound played. The system 2 can then remix the same audio data set to 70% audio data set and 30% noise and audibly play that audio output data to the subject. The subject can then enter input data into the system 2 that the subject does understand the sound played. The system 2 can then remix the same audio data set to 65% audio data set and 35% noise and audibly play that audio output data to the subject.

The iterative optimizing process can continue until the change in processing is below a desired threshold.

All the data from the processing, and the subject's input data can be stored in memory (e.g., a database 10) and linked to identification data for the individual subject. The subject's input data (e.g., how many iterations until they understood the sound) and/or the processing data (e.g., what the sound-to-noise ratio was when the subject understood the sound) can be stored in memory (e.g., a database 10) and linked to identification data for the individual subject

The audio transducers 156 can be speakers and/or headphones, for example as shown and described herein. The audio engine 134 can process the audio output data differently depending on the specific audio transducers 156 used with the system 2. The audio engine 134 can optimize (e.g., equalize) the audio output data depending on the specific audio transducers 156 used with the system 2 to create the clearest audio from those specific audio transducers 156.

Module Application

The module application 132 can perform the iterative optimizing process described above. The module application 132 can also process the audio data set.

The module application 132 can include data sets. The audio data sets can be stored with data compression. The module application 132 can compress and/or decompress the audio data sets, for example using a general purpose codec or high quality speech compression, for example ICELP 10 kHz wide-band speech codec, and True Speech codec. Examples of compression methods are shown and described herein. The subject can select audio data sets based on the subject's personal interests (e.g., data sets can be based on dogs for dog lovers, specific sports teams for fans of that sports team).

The module application 132 can establish a baseline score for each subject during the first one or few times the subject uses the aural rehabilitation system 2. An initial test can have the subject perform all or some of the available modules performed by the module application 132 to establish the baseline score. Future scores can be tracked relative to the baseline. The use of the system 2 can also be recorded for the system 2 and/or for each subject, such as the times of use, dates of use, durations of use, and number of iterations performed by each subject.

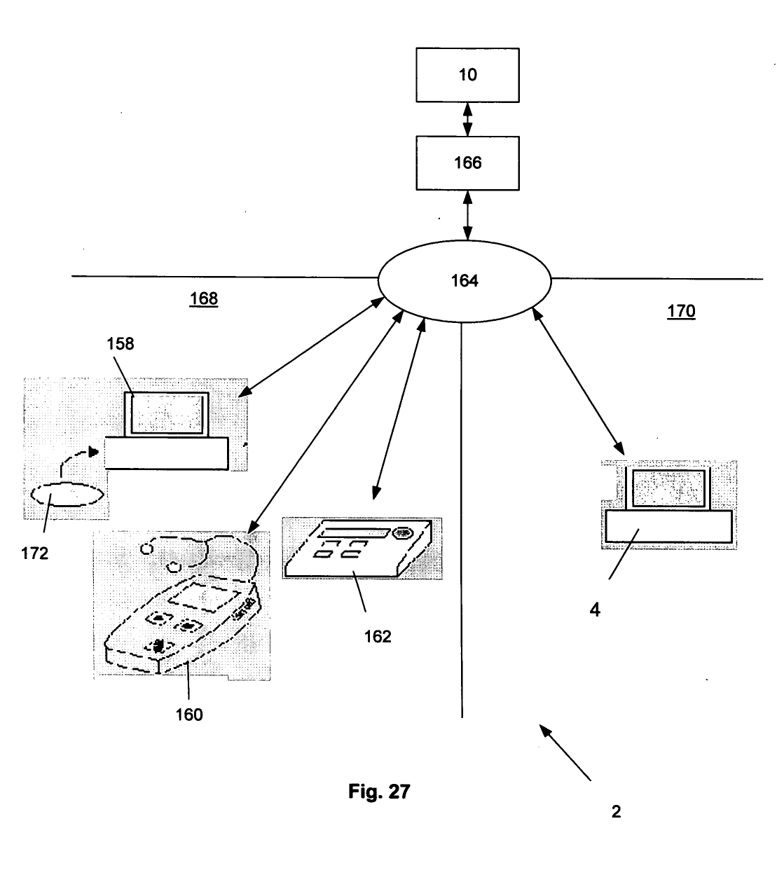

FIG. 27 illustrates that the system 2 can include (cumulative referred to as the local devices 8) a subject's PC 158 and/or a first local device 160 and/or a second local device 162. The local devices 8 can be in two-way communication with a WAN 164. Via the WAN 164, the local devices 8 can be in two-way communication with the database 10 and/or the physician's device 4.

The first local device 160 and/or second local device 162 can be activated by the module application 132 or otherwise by the aural rehabilitation system 2. The first and/or second local devices 160 and/or 162 can be required to be re-activated (i.e. renewed) by new software, or renewed software, each time a new subject uses the system 2. The subject's PC 158 can receive and/or send copy protection information via the WAN 164 to and/or from the database 10 and/or the physician's device 4.

The local devices 8 can synchronize with the database 10 and/or the physician's device 4 via the WAN 164. The local devices 8 can upload the usage and/or progress of the local devices 8 via the WAN 164. The local devices 8 can download rehabilitation/therapy prescription via the WAN 164.

The database 10 can be in two-way communication with a WAN 164 such as the internet. For example, the database 10 can utilize a web application 166, such as HTTPS (e.g., on the remote device 6 and/or database 10).

The local devices 8 can be at a subject location 168. The physician's device 4 (e.g., a doctor's PC) can be at a physician (e.g., doctor) location 170.

The physician's device 4 can be in two-way communication with the WAN 164. Via the WAN 164, the physician's device 4 can be in two-way communication with the database 10 and/or the local device(s) 8. The physician's device 4 can access patient records and usage. The physician's device 4 can change the patient therapy prescription. The physician's device 4 can edit and send billing and insurance information.

The subject's PC 158 can receive, as shown by arrow, a compact disc 172.

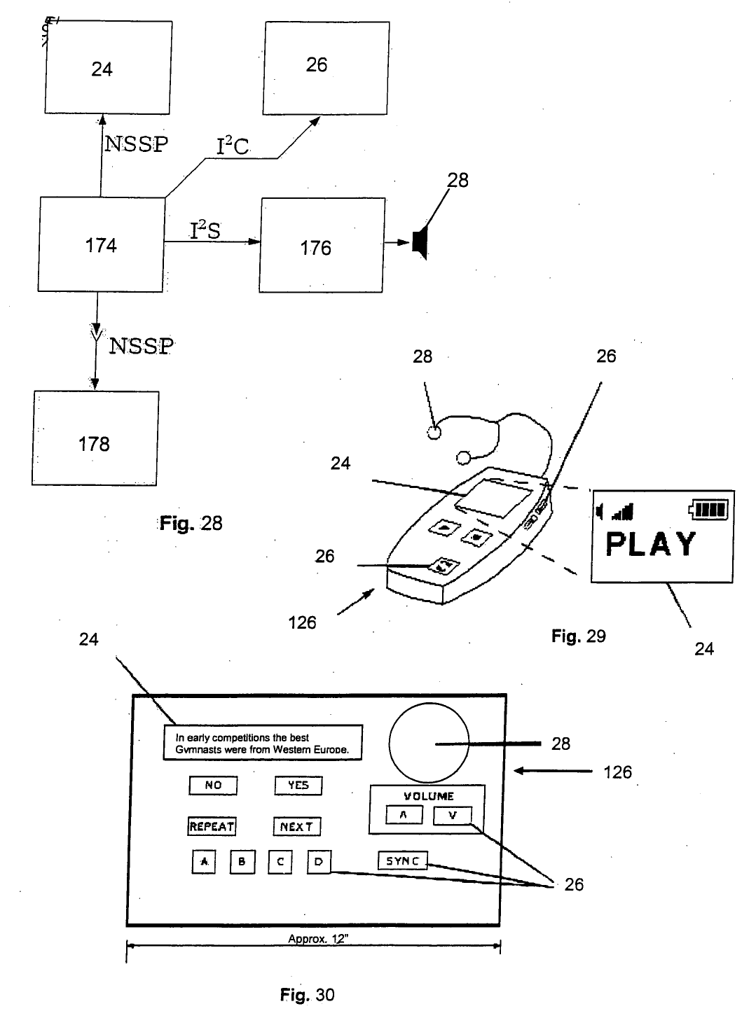

FIG. 28 illustrates an embodiment of a local device 8, for example the second device of FIG. 27. The local device 8 can have a 400 Mhz Xscale CPU (i.e., processor 174) with board and with 32 MB Flash memory and 64 MB of RAM. The local device 8 can have the visual screen 24, such as a display, for example with 65×105 mono resolution display. The local device 8 can have a modem 178. The local device 8 can have an audio output 176, for example directly coupled and 50 mW. The local device 8 can have the external transducer 28, such as an acoustic speaker. The local device 8 can have the user controls 26, such as buttons. The processor 174 can be in communication with the display, for example, via a network synchronous serial port (NSSP). The processor 174 can be in communication with the modem 178, for example, via an NSSP. The processor 174 can be in communication with the user controls 26, for example via an I²C. The processor 174 can be in communication with the audio output 176, for example via an I²S. The audio output 176 can be in communication with the external transducer 28.

FIG. 29 illustrates an embodiment of the hardware interface 126, such as the hardware interface 126 of the first device of FIG. 27. The visual screen 24 can display information such as the status of the power source (e.g., battery charge), audio volume, and activation status (e.g., playing).

FIG. 30 illustrates an embodiment of the hardware interface 126, such as the hardware interface 126 of the second device of FIG. 27. The hardware interface 126 can have a hardware interface 126 width, for example about 30 cm (12 in.). The layout of the user controls 26 and/or the visual screen 24 and/or the external transducer 28 can be shown to scale. The visual screen 24 can display text. The user controls 26 can include: volume up and down controls, a synchronization control, a control to repeat an exercise, a control to advance to the next exercise, controls to respond yes, no, A, B, C, and D.

The memory of the system 2 can record the number of modules attempted, the number of modules correctly performed, what type of modules have been performed. The performance of each module, and the usage of a baseline score in the modules. The baseline score can be used to track improvement or other change by the subject.

The memory can include a database 10, such as the database 10 shown and described herein. The database 10 can receive data from, or have two-way communication with the aural rehabilitation system 2, for example with the module application 132. The communication with the database 10 can be the same as that shown and described herein.

Second Architecture

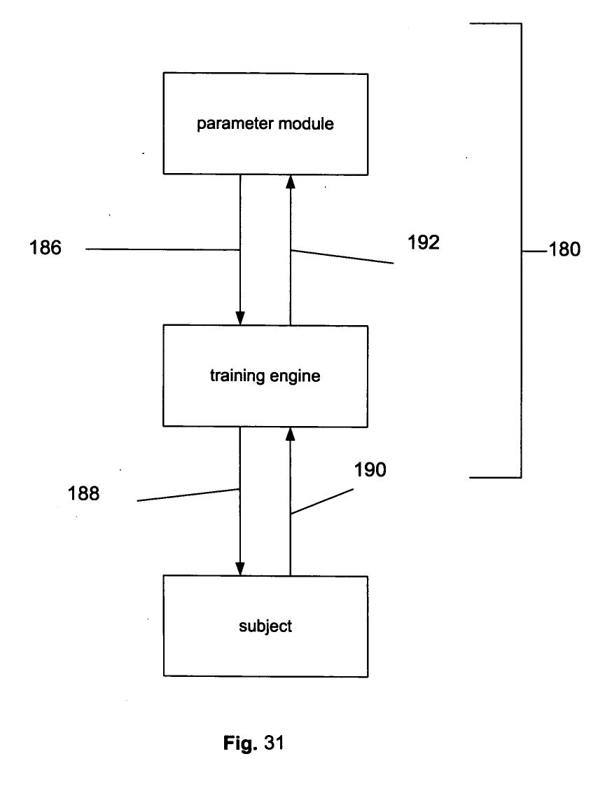

FIG. 31 illustrates a hardware and/or software second architecture 180 and a subject for the neurological rehabilitation system 2, such as an adaptive threshold training system. This second architecture 180 can be used in conjunction with the first architecture 128 or any other architectures disclosed herein, and/or elements of the architectures can be directly combined or otherwise integrated.

As described supra, the system 2 can be a single device or multiple devices. The system 2 can be all or part of the systems described herein. The treatment herein can include augmentation and/or diagnosis and/or therapy. The condition that can be treated can be any neurological process amenable to treatment or augmentation by sound, for example aural rehabilitation (e.g., hearing air training or rehabilitation) or otological or audiological disorders such as tinnitus or other pathologies where retraining of the auditory cortex using auditory stimulus and/or training protocols to improve function is possible. Other examples of treatment of audiological conditions include refining or training substantially physiologically normal hearing, stuttering, autism or combinations thereof. The system 2 can also be used, for example, for phoneme training (e.g., in children or adults), foreign language training, and hearing aid parameter determination testing.

The second architecture 180 can have a training engine 182 and a parameter module 184 that can have parametric data 186. The training engine 182 and/or parameter module 184 can be software (e.g., executable programs, scripts, databases 10, other supporting files), electronics hardware (e.g., a processor or part thereof), or combinations thereof. The parametric data 186 can include multimedia files (e.g., for text, images, audio, video), schedule data, meta data, or combinations thereof.

The training engine 182 can be configured to directly or indirectly receive the parametric data 186 from the parameter module 184. The training engine 182 and parameter module 184 can be, for example, on the same device (e.g., as an executable program on a hard drive connected to and executed by a processor and a database 10 on a storage device, such as a compact disc, in a compact disc reader in communication with the same processor), or via a network, or combinations thereof. The training engine 182 can produce multimedia output 188. The multimedia output 188 can include text, images, audio, video, or combinations thereof, or files communicating an aforementioned form of multimedia output 188 to an output device (e.g., a video display, speakers).

The multimedia output 188 can be delivered directly or indirectly to a subject. The subject can be the intended recipient of the treatment, training, or testing; a therapist (e.g., physician or audiologist); a person or other animal whom the intended recipient of the treatment, training, or testing is familiar; or combinations thereof.

The subject can directly or indirectly provide subject data 190 to the training engine 182 (as shown) and/or the parameter module 184. The subject data 190 can include test results (e.g., scores), audio data (e.g., voice samples, room sound test samples), physiological data (e.g., pulse, blood pressure, respiration rate, electroencephalogram (EEG)), or combinations thereof.

The training engine 182 can analyze the subject data 190 and send analyzed results 192 (e.g., analyzed session data) and raw data (not shown) to the parameter module 184. The analyzed results 192 and raw data can include the performance of the subject during the training. The performance can include a recording of the subject's responses to training. The performance can include a score of the subject's performance during training. The score can include performance results (e.g., scores) for each module and/or for specific characteristics within each module (e.g., performance with Scottish accents, performance with sibilance, performance with vowels, individual performances with each phoneme).

The training engine 182 can use the analyzed results 192 and raw data to modify the training schedule. For example, the schedule modification can be performed automatically by an algorithm in the training engine 182, and/or manually by a physician, and/or a combination of an algorithmic modification and a manual adjustment. Modifications of the schedule can include increases and/or decreases of total length of training time and/or frequency of training of particular training modules based on the scores; and/or modifications can be based wholly or partially on a pre-set schedule; and/or modifications can be based wholly or partially on a physician's adjustments after reviewing the results of the training.

The second architecture 180 can execute one or more of the training modules described herein. The text of any of the training modules can be visually displayed before and/or during and/or after each training exercise.

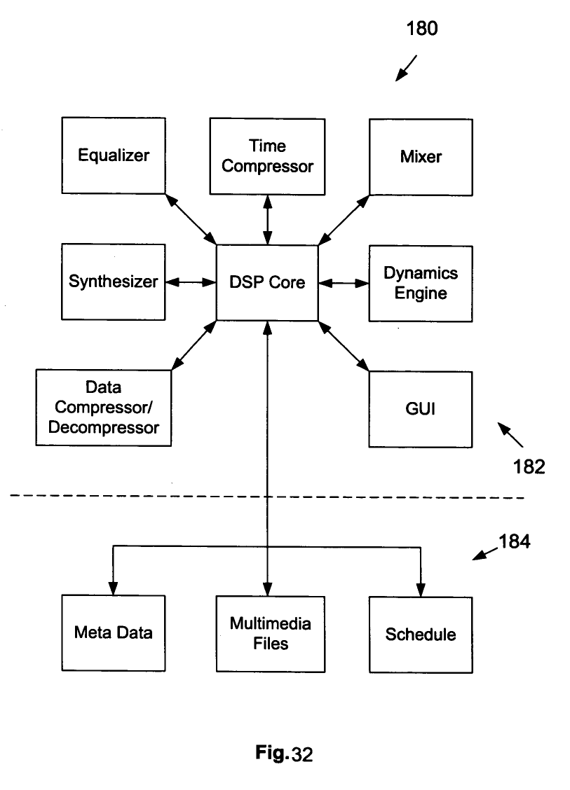

FIG. 32 illustrates that the training engine 182 can have a digital signal processing (DSP) core. The DSP core can be configured to process the parametric data 186, including audio and/or video data, and/or some or all of the subject data 190. The DSP core can interact with one or more functions. The DSP Core can communicate with one or more components. The components can be functions within, or executed by, the DSP core, separate programs, or combinations thereof. The components can include a data compressor and/or decompressor, a synthesizer, an equalizer, a time compressor, a mixer, a dynamic engine, a graphical user interface (GUI), or combinations thereof.

The data compressor and/or decompressor can be configured to compress and/or decompress any files used by the training engine 182. The data compressor and/or decompressor can decompress input data files and/or compress output data files.

The DSP core can download and/or upload files over a network (e.g., the internet). The compressor and/or decompressor can compress and/or decompress files before and/or after the files are uploaded and/or downloaded.

The synthesizer can be configured to create new multimedia files. The new multimedia files can be created, for example, by recording audio and/or video samples, and by using methods known to those having ordinary skill in the art to create new multimedia files using the samples. The synthesizer can record samples of a non-familiar or a familiar voice and/or image to the intended recipient of the treatment, training or testing, for example the voice or image of the intended recipient's spouse or friend.

The new multimedia files can be created for the substantive areas desired for the particular intended recipient of the treatment, training or testing. For example, if the intended recipient performs poorly distinguishing “th” from “s” phonemes, the synthesizer could create new multimedia files and the accompanying meta data with a high concentration of “th” and “s” phonemes.

The equalizer can be configured to control the gain of sound characteristics ranges individually, in groups, or for the entirety of the audio output. The sound characteristics ranges can include frequency, phonemes, tones, or combinations thereof. The equalizer can be configured to process audio output through a head-related transfer function (HRTF). The HRTF can simulate location-specific noise creation (e.g., to account for sound pressure wave reflections off of the geometry of the ears).

The time compressor can be configured to increase and/or decrease the rate of the multimedia output 188. The time compressor can alter the rate of audio output with or without altering the pitch of the audio output.

The mixer can combine multiple sounds with individual gains. The mixer can combine noise with the multimedia output 188. The mixer can combine a cover-up sound (e.g., another word, a dog barking, a crash, silence) with the multimedia output 188 such that a target sound (e.g., a target word in a cognitive training exercise) is covered by the cover-up sound. The mixer can increase and/or decrease the gain of the noise and, separately or together, increase and/or decrease the gain of the multimedia output 188.

The GUI can have one or more settings. Each setting can be pre-included or can be added via an expansion module. Each setting can be particular to a particular subject preference. For example, one setting can be tailored to children (e.g., cartoon animals, bubble letters), one setting can be tailored to a non-English character language (e.g., katakana and hiragana alphabets), one setting can be tailored to English speaking adults, one setting can be tailored to autistic children. The setting of the GUI can be changed or kept the same for each use of the training system 2.

The dynamic engine can create dynamic effects, for example environmental effects, in the multimedia output 188. The dynamic engine can create reverberation in audio output. The reverberation can simulate sound echoing, for example, in a large or small room, arena, or outdoor setting.

The dynamic engine can tune and/or optimize (e.g., tone control) the speakers, for example, for the local environment. A microphone can be used to detect a known sample of audio output played through the speakers. The dynamic engine can analyze the detected sample input through the microphone. The analysis by the dynamic engine can be used to alter the audio output, for example, to create a flat frequency response across the frequency spectrum.

The dynamic engine can create artificial acoustic environments (e.g., office, tank, jet plane, car in traffic).

The dynamic engine and/or equalizer can adjust the characteristics of the audio output (e.g., gain of frequency range, reverberation) based on audio received during the subject's response to the training. The characteristics of the audio output can be continuously or occasionally adjusted, for example, to accommodate for room size and frequency response.

Video displays can be used in conjunction with audio to train, for example, for lip reading.

The parameter module 184 can include meta data, multimedia files, a schedule, or any combination thereof. The meta data can include the text and/or characteristics (e.g., occurrences of each phoneme) for the multimedia files. The multimedia files can include audio files, video files, image files, text files, or combinations thereof. The schedule can include schedules for training including which modules, which characteristics (e.g., phonemes, sibilance), other training delivery data, or combinations thereof.

Method of Training

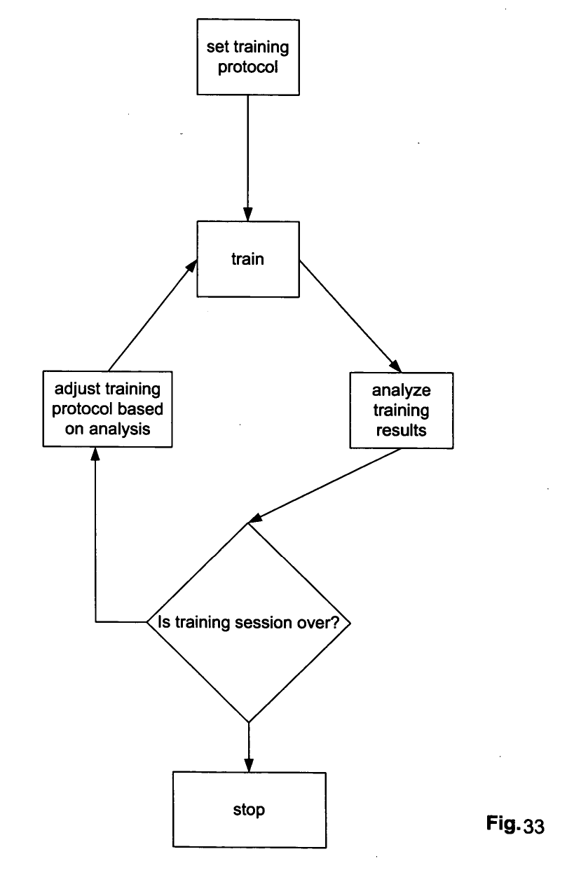

FIG. 33 illustrates a method of training, such as a neurological or audiological training. This method of training can be used in conjunction with other methods described herein.

An initial assessment 66 of an audiological disorder, such as hearing loss, can be made, for example by a physician during a visit with a patient. The training system 2 can then be initialized. During initialization, a training protocol can be set by the physician and/or by the system 2. The training system 2 can then be used for training, as described above.

A training session can be made of numerous training exercises. After a training exercise or set of exercises, the system 2 (e.g., the DSP core and/or processor) can analyze the training results. The training can stop when the training results are sufficient to end the training session (e.g., due to significant improvement, significant worsening, or a sufficient quantity of exercises—any of these limits can be set by the physician and/or the system 2) or the subject otherwise ends the training session (e.g., manually).

If the training session does not end, the training protocol can be adjusted based on the analysis of the training results. If the subject is having slower improvement or worsening performance with a particular training module relative to the other training modules, the system 2 can increase the number of exercises the subject performs in that poorly performed module. If a subject is performing poorly with a specific characteristic of a particular module (e.g., sibilance in the competing speech module), the system 2 can increase the incidence of that poorly performing characteristic for future training exercises in the particular module, and/or in other modules.

The system 2 can make step increases in training delivery characteristics based on subject performance. For example, if the subject performs well, the system 2 can increase the amount of degradation for the degraded speech training module. If the subject performs poorly, the system 2 can decrease the amount of degradation for the degraded speech training module. The step increase can occur after each exercise and/or after a set of exercises, and/or after each session. The step increases can decrease as the system 2 narrows down a range of optimum performance for the subject. The step increases can increase if the subject's performance begins to change rapidly.

The system 2 can record performance with the corresponding time of day, date, sequential number of exercise (e.g., results recorded and listed by which exercise it was in a particular session, such as first, second, third, etc.), or any combination thereof.

It is apparent to one skilled in the art that various changes and modifications can be made to this disclosure, and equivalents employed, without departing from the spirit and scope of the invention. Furthermore, synonyms are used throughout this disclosure and are not intended to be limiting. For example, the subject can be equivalent to the patient. Also, numerous species are used as specific examples in lieu of the genus, but any species of that genus disclosed herein can be substituted for the specific example species listed. For example, augmentation, rehabilitation and training can be equivalent, and all of which can be classified as treatments. The aural rehabilitation system 2 and training systems 2 can be equivalents to each other and equivalent to, or a species of, the treatment system 2. All architectures listed herein can be software and/or hardware. Elements shown with any embodiment are exemplary for the specific embodiment and can be used on other embodiments within this disclosure.

We claim:

1. A system for aural rehabilitation for a subject comprising:
an audio engine, wherein the audio engine is configured to alter a sound data.

2. The system of claim 1, wherein altering a sound data configuration comprises optimizing and/or iterating the sound data based on a subject response.

3. The system of claim 2, wherein optimizing and/or iterating comprises audibly playing the sound data, and wherein the subject responds with input data, and wherein the audio engine alters the sound data in a positive direction or a negative direction based on the input data.

4. The system of claim 3, further comprising a module application, wherein the module application optimizes and/or iterates based on a subject's response.

5. A method for aural rehabilitation comprising:
executing an audio engine and/or module application on a processing hardware,
mixing audio data and noise at a first ratio,
receiving an input, and
mixing audio data and noise at a second ratio.

6. The method of claim 5, wherein the audio engine and/or module application performs the mixing audio data and noise to a first ratio and the mixing audio data and noise to a second ratio.

7. The method of claim 6, wherein the mixing is performed on the fly.

8. The method of claim 7, wherein the mixing is performed by the audio engine and/or module application with the input.

9. The method of claim 7, wherein the mixing is performed by the audio engine and/or module application based on the input.

10. The method of claim 5, wherein the input consists of an input from a subject whom is receiving the aural rehabilitation.

11. The method of claim 5, wherein the input comprises input from a subject whom is receiving the aural rehabilitation.

12. A method for aural rehabilitation comprising:
executing an audio engine and/or module application on a processing hardware,
delaying an audio data for a first delay time,
receiving an input, and
delaying an audio data for a second delay time.

13. The method of claim 12, wherein the audio engine and/or module application performs the delaying an audio data for a first delay time and the delaying an audio data for a second delay time.

14. The method of claim 13, wherein the delaying is performed on the fly.

15. The method of claim 12, wherein the delaying is performed by the audio engine and/or module application based on the input.

16. The method of claim 12, wherein the input consists of an input from a subject whom is receiving the aural rehabilitation.

17. The method of claim 12, wherein the input comprises input from a subject whom is receiving the aural rehabilitation.

18. A method for aural rehabilitation comprising:
executing an audio engine and/or module application on a processing hardware,
time compressing an audio data for a first time compression ratio,
receiving an input, and
time compressing an audio data for a second time compression ratio.

19. The method of claim 18, wherein the audio engine and/or module application performs the time compressing an audio data for a first time compression ratio and the time compressing an audio data for a second time compression ratio.

20. The method of claim 19, wherein the time compressing is performed on the fly.

21. The method of claim 18, wherein the time compressing is performed by the audio engine 134 and/or module application based on the input.

22. The method of claim 18, wherein the input consists of an input from a subject whom is receiving the aural rehabilitation.

23. The method of claim 18, wherein the input comprises input from a subject whom is receiving the aural rehabilitation.

24. A method for aural rehabilitation comprising:
executing an audio engine and/or module application on a processing hardware,
distorting an audio data to a first distortion level,
receiving an input, and
distorting an audio data to a second distortion level,.

25. The method of claim 24, wherein the audio engine and/or module application performs the distorting an audio data to a first distortion level and the distorting an audio data to a first distortion level,.

26. The method of claim 25, wherein the distorting is performed on the fly.

27. The method of claim 24, wherein the distorting is performed by the audio engine and/or module application based on the input.

28. The method of claim 24, wherein the input consists of an input from a subject whom is receiving the aural rehabilitation.

29. The method of claim 24, wherein the input comprises input from a subject whom is receiving the aural rehabilitation.
